(19) United States
(12) Patent Application Publication
(10) Pub. No.: US 2024/0236761 A1
(43) Pub. Date: Jul. 11, 2024

(54) BACKHAUL LINK ISSUES IN AN INTEGRATED ACCESS AND BACKHAUL NETWORK

(71) Applicant: CANON KABUSHIKI KAISHA, Tokyo (JP)

(72) Inventors: Pascal LAGRANGE, La Chappelle des Fougeretz (FR); Pierre VISA, RENNES (FR)

(21) Appl. No.: 18/563,326

(22) PCT Filed: May 27, 2022
(86) PCT No.: PCT/EP2022/064388

§ 371 Date: Nov. 21, 2023

(30) Foreign Application Priority Data
May 27, 2021 (GB) 2107607.0

(51) Int. Cl. H04W 28/02; H04W 24/04

(52) U.S. Cl. CPC H04W 28/0289; H04W 24/04

(57) ABSTRACT

A method at an Integrated Access and Backhaul, IAB, node of an IAB network is disclosed. The IAB network includes a donor Central Unit, CU. The method comprises detecting a link issue for transmission of data over a backhaul link of the IAB network and in response to detecting the link issue, sending a link failure notification to the donor CU. The link failure notification includes link identification information identifying the backhaul link and link issue information relating to the detected link issue including information associated with a cause of the detected link issue. A cause of the detected link issue may be one of link recovery failure, slow recovery of link issue or recurring link issues.

### FIELD OF THE INVENTION

The present invention generally relates to backhaul link issues in an integrated access and backhaul, IAB, network of a wireless communication system. More particularly, the present invention relates to detecting link issues in an IAB network.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems-based IEEE 802.11 standards, such as WiFi.

The demand for network densification (e.g. denser placement of base stations) increases due to the rising number of users and higher throughput requirement.

Facing the issues of high deployment costs and time of the wired backhaul networks with network densification, 3GPP has proposed, in recent release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications or links (between base stations) may use the same radio resources as access communications or links (between a base station and UEs).

IAB turns out to be a competitive alternative to the fiber-based backhauling in dense areas or areas difficult to cover, as it allows scalable and rapid installations without the burden of cabling the base stations.

An IAB network includes an IAB node or IAB base station (also referred to as the “IAB-donor”) directly connected to the core network via non-IAB backhaul, for example fiber-based backhaul, and a plurality of IAB nodes or IAB base stations. Multiple backhaul paths are set up between the IAB donor and the IAB node serving a UE also referred to as the “access IAB-node” for the UE). Several intermediate IAB nodes may be involved in each of the several backhaul paths between the IAB-donor and the access IAB-node, thus forming alternative data paths within a multi-hop IAB network.

In the IAB-network topology, the direction from the IAB-donor toward the access IAB-nodes (and thus the UEs) is referred to as downstream, hence defining a parent IAB-node and a child IAB-node for each link. The direction toward the IAB-donor is referred to as upstream. Each IAB-node coupled directly or indirectly to the IAB-donor comprises an IAB-MT (IAB-Mobile Termination) to communicate in the upstream direction and an IAB-DU (IAB-Distributed Unit) to communicate in the downstream direction.

Like a legacy 5G base station (gNB), the IAB-donor consists of a central unit (CU or gNB-CU functionality) and of one or more distributed unit(s) (DU or gNB-DU functionality). The IAB-donor-CU hosts higher layer protocols for controlling operation of one or more DUs and each of the one or more IAB-donor-DUs include lower layer protocols including the Physical layer and Radio Frequency part. The IAB-donor-CU and the one or more IAB-donor-DUs may be located far from each other. Then a wired IP network (typically with fiber connections) exists to interconnect these different devices. The interest of having several DUs connected to a single CU is the centralization and the resource sharing of less time-critical operations in the CU (virtualization), while time-critical operations like scheduling, fast retransmission, segmentation, etc. . . . are performed in the DUs. As a consequence, in the downstream direction, there may be several backhaul paths from the IAB-donor-CU to an IAB-node through different IAB-donor-DUs. Similarly in upstream direction, there may be several possible backhaul paths from the source IAB-node to reach the IAB-donor-CU through different IAB-donor-DUs.

To enable routing over multiple backhaul hops, a specific IAB protocol sublayer was introduced, the backhaul adaptation protocol (BAP) sublayer, which is specified in the 3GPP release-16 specifications TS 38.340 (version 16.3.0). There is one BAP entity in an IAB-MT, one BAP entity in an IAB-DU, and one BAP entity in an IAB-donor-DU. A unique BAP address is assigned to each IAB-node and to each IAB-donor-DU by the IAB-donor CU in charge of managing the IAB network. The BAP sublayer encapsulates IP SDUs (Service Data Units) into BAP PDUs (Protocol Data Units), where each BAP PDU consists of a BAP header and a payload section, which includes the IP SDUs.

IAB is most likely to operate in the millimeter wave (mmWave) band to achieve the required Gbps (gigabits per second) data rate.

However, millimeter waves are known to be subject to strong attenuations of signal strength in some weather conditions (rain, fog), and to blockage in case of obstacles located in the path between the emitter and the receiver which may result in frequent radio link failures.

To cope with these potential radio link failures, a topological redundancy can be provided within the IAB framework, where multiple backhaul paths are set up between the IAB-donor and the access IAB-node via several intermediate IAB-nodes providing alternative backhaul paths as discussed above.

A path through a set of IAB-nodes is defined by default along which the data are preferably transmitted. Also, one or more back-up paths along different sets of IAB-nodes are defined that can be used in case a radio link failure (RLF) occurs on any link of the default path. A link is defined between two successive IAB-nodes in the backhaul network. A back-up path is also useful in case of congestion of a link due to an excessive demand of application traffic compared to the default link capacity which may vary due to link quality of the link. Traffic re-routing to a back-up path or load balancing between the default path and one or more back-up paths may be activated to mitigate the congestion.

RLF and congestion are two types of backhaul (BH) link issues. Traffic re-routing or load balancing may help to mitigate short-term (i.e. transient) BH link issue (RLF/BH link quality/congestion) phenomena. In other words, short-term BH link issues are BH link issues which have a short duration and can be recovered from quickly (e.g. due to quick recovery of link quality). However, the traffic re-routing or load balancing may increase the risk of congestion at another IAB-node, as the IAB-node that performs the re-routing does not have any knowledge of the link quality or congestion level at remote IAB-nodes.

Thus, even if local re-routing, by allowing fast link adaptation, provides an efficient means to mitigate the impact of a short-term BH Link issue, it may not be suitable for a long-term BH link issue, i.e. a recurring or long-lasting BH link issue. A long-term BH Link issue may thus require the IAB-Donor to reconfigure the routing configuration of all or part of the IAB-nodes, as the IAB-Donor is the only node having the knowledge of the whole IAB network topology.

3GPP Rel.16 specification defines few services to report to the IAB-Donor of any local BH Link issue. In this respect, there is no signaling specified for long-term BH link issue reporting. As discussed previously, even if a short-term BH link issue may be mitigated by an IAB-node through local re-routing, a long-term BH link issue may require a new routing configuration of all or part of the IAB-nodes in order to adapt to the new situation arising due to the long-term BH link issue. However, the IAB-Donor does not have any knowledge of local IAB issues, either short-term or long-term (as of Rel. 16).

Therefore, some new mechanisms are required to overcome the aforementioned issues, while limiting the complexity of the processing at an IAB-node as well as the latency that would result from such processing.

### SUMMARY

In accordance with a first aspect of the present invention, there is provided a method at an Integrated Access and Backhaul, IAB, node of an IAB network, the IAB network including a donor Central Unit, CU, the method comprising: detecting a link issue for transmission of data over a backhaul link of the IAB network; in response to detecting the link issue, sending a link failure notification to the donor CU, wherein the link failure notification includes link identification information identifying the backhaul link and link issue information relating to the detected link issue including information associated with a cause of the detected link issue.

Thus, by detecting a link issue, and in response to detecting the link issue, sending a link failure notification to the donor CU, link issues can be identified at the IAB node and link failure notifications sent to the donor CU on detection of the link issues with information associated with the cause of the link issue so that the donor can identify the cause or the type of the cause and reconfigure routing configuration of some or all of the IAB nodes in the IAB network if required to ensure prompt and efficient handling of link issues to minimize service interruption. As the link failure notifications from the IAB nodes in the IAB network can provide the donor CU with information about local link issues occurring at the IAB nodes, the donor CU has more detailed knowledge of link issues in the IAB network and so can determine a more effective reconfiguration of the IAB network required to address the link issues compared to when the donor CU does not have information about local link issues.

The information associated with the cause of the link issue may include information indicating the cause of the detected link issue or information indicating a type of the cause of the detected link issue. For example, the type of cause of the detected link issue is one of a long-term cause (e.g. resulting in a long-term link issue) or a short-term cause (resulting in a short-term link issue).

The cause of the detected link issue may include one of: link recovery failure; slow recovery of link issue; recurring link issues. For example, each of such causes is a long-term cause resulting in a long-term link issue or long-term failure.

Short-term causes may include too much data to be transmitted over a backhaul link which lasts only a short period of time (i.e. is recovered from in a short period of time) resulting in congestion as a short-term link issue or link quality for a backhaul link being less than a threshold level which lasts only a short period of time (i.e. is recovered from in a short period of time) resulting in Radio Link Failure, RLF, as a short-term link issue.

The method may further comprise determining whether the detected link issue provides a long-term link issue, wherein sending a link failure notification to the donor CU is in response to determining the detected link issue provides a long-term link issue.

Thus, by determining whether the detected link issue provides a long-term link issue and in response to determining the detected link issue provides a long-term issue, sending a link failure notification to the donor CU, long-term link issues can be identified at the IAB node and notifications sent to the donor CU on detection of the long-term link issues so that the donor can identify the cause of the long-term link issue and reconfigure routing configuration of some or all of the IAB nodes in the IAB network to ensure prompt and efficient handling of long-term link issues to minimize service interruption. In other words, long-term link issues may be differentiated from short-term link issues and can be handled efficiently at the donor CU through the link failure notifications.

A long-term link issue or long-term failure requires reconfiguration by the donor CU (or IAB-donor CU) of routing configuration in the IAB network (e.g. of some or all of the IAB nodes in the IAB network) whereas a short-term link issue or short-term failure can be handled locally at the IAB-node. A long-term link issue may be a recurring or repeating or successive link issue or long-lasting link issue that takes a long time to be recovered from or a link issue that cannot be recovered and thus requires reconfiguration of routing configuration in the IAB network by the donor CU. Short-term failure or short-term BH link issues are failures or BH link issues which are transient having a short duration and which can be recovered from quickly (e.g. quick recovery of link quality or broken link and/or with local action at one or more IAB nodes) and without requiring the donor CU to reconfigure routing configuration of all or some of the IAB nodes. Long-term failure or long-term BH link issues are failures or BH link issues which cannot be recovered from or which repeat over a short period of time, or which cannot be recovered from quickly and all of which require the donor CU to reconfigure the routing configuration of all or some of the IAB nodes in the IAB network.

The detected link issue may be a Radio Link Failure, RLF, of the backhaul link or congestion affecting transmission of data over the backhaul link.

In an example, the link issue information relating to the detected link issue further includes at least one of: information indicating a nature of the detected link issue; information identifying a type of the detected link issue; information indicating the link quality of the backhaul link; link issue time information indicating a time between detecting the link issue and sending the link failure notification.

In an example, the IAB node comprises a Mobile Termination, MT, and wherein detecting a link issue for transmission of data over the backhaul link and sending a link failure notification to the donor CU are performed by the MT of the IAB node.

In an example, the link failure notification may be sent by the MT of the IAB node in an RRC message.

In an example, the IAB node comprises a Distributed Unit, DU, and wherein detecting a link issue for transmission of data over the backhaul link and sending a link failure notification to the donor CU are performed by the DU of the IAB node.

In an example, the link failure notification may be sent by the DU of the IAB node in a F1 Application Protocol, F1-AP, layer message.

In accordance with a second aspect, there is provided a method at donor Central Unit, CU, of an Integrated Access and Backhaul, IAB, network, as recited in any one of claims 24 to 33 of the accompanying claims.

In accordance with a third aspect, there is provided an Integrated access and backhaul, IAB, node, as recited in claim 34.

In accordance with a fourth aspect, there is provided a donor Central Unit, CU, as recited in claim 35.

In accordance with a fifth aspect, there is provided a method at donor Central Unit, CU, of an Integrated Access and Backhaul, IAB, network, the IAB network including a plurality of IAB nodes, the method comprising:
sending, by the CU to the plurality of IAB nodes, backhaul link failure configuration information including:
information indicating a maximum number of detected consecutive link issues for data transmission over the backhaul link;
recovery timeout information indicating a maximum time period between a time of detection of a link issue and a time of recovery from the detected link issue;
a link issue recovery time window having a predetermined length, during which a maximum number of consecutive link issues may be detected.

In accordance with a sixth aspect of the present invention there is provided a method at an Integrated Access and Backhaul, IAB, node of an IAB network, the IAB network including a donor Central Unit, CU, the method comprising:
detecting a link issue for transmission of data over a backhaul link of the IAB network;
in response to determining a predetermined link failure criterion (also referred to as predetermined link issue criterion) is met for data transmission over the backhaul link, sending a link failure notification to the donor CU, wherein the link failure notification includes link identification information identifying the backhaul link and link issue information relating to the detected link issue, including information associated with the predetermined link failure criterion determined to have been met.

The predetermined link issue criterion represents a cause of a link issue and the information associated with the predetermined link issue criterion may include information indicating the cause of the detected link issue or a type of the cause of the detected link issue. For example, the type of cause of the detected link issue is one of a long-term cause (e.g. resulting in a long-term link issue) or a short-term cause (resulting in a short-term link issue).

The cause of the detected link issue may include one of: link recovery failure; slow recovery of link issue; recurring link issues. For example, each of such causes is a long-term cause resulting in a long-term link issue or long-term failure.

The method may further comprise checking whether the detected link issue relates to a backhaul link recovery failure and when the detected link issue relates to a backhaul link recovery failure, determining the predetermined link failure criterion is met.

The method may further comprise when the detected link issue does not relate to a backhaul link recovery failure, checking whether a number of detected consecutive link issues reaches a threshold corresponding to a maximum number of consecutive link issues, and when the number of detected consecutive link issues reaches the threshold, determining the predetermined link failure criterion is met.

The method may further comprise when the detected link issue does not relate to a backhaul link recovery failure, checking whether a number of detected consecutive link issues, detected during a link issue recovery time window having a predetermined length, reaches a threshold, and when the number of detected link issues reaches the threshold, determining the predetermined link failure criterion is met.

The method may further comprise when the number of detected link issues does not reach the threshold, determining whether the detected link issue is recovered, and in response to determining the detected link issue is not recovered within a recovery timeout period or in response to determining a backhaul link recovery failure, determining the predetermined link failure criterion is met.

In summary, to mitigate service interruption when one or more BH links are experiencing long-term BH link issue, new methods and associated Information Elements are added to the existing 3GPP IAB framework.

In summary, to mitigate service interruption when one or more BH links are experiencing long-term BH link issue, new methods and associated Information Elements are added to the existing 3GPP IAB framework.

Further features of the invention are characterised by the other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with another aspect of the invention, there is provided a computer readable storage medium storing at least one computer program comprising instructions that, when executed by a processing unit, causes the processing unit to perform the method according to any aspect or example described above.

It should also be appreciated that particular combinations of the various features described and defined in any aspects of the invention can be implemented and/or supplied and/or used independently.

### BRIEF DESCRIPTION OF THE DRAWINGS

Different aspects of the invention will now be described, by way of example only, and with reference to the following drawings in which:

FIG. 1 is a schematic diagram illustrating a wireless communication system including a wireless Integrated Access and Backhaul (IAB) network;

FIGS. 2a and 2b are schematic diagrams illustrating stacks of some protocol layers involved in IAB operations;

FIG. 3 is a schematic diagram illustrating the format of a BAP Protocol Data Unit (PDU) or packet;

FIG. 4 is a schematic diagram illustrating the routing management in an IAB network;

FIG. 5 illustrates fields of routing tables in IAB-nodes according to 3GPP TS 38.300;

FIG. 6 is a schematic diagram illustrating an example topology of an IAB network arrangement in which the present invention may be implemented according to one or more exemplary embodiments;

FIG. 7 illustrates, using a flowchart, an exemplary method for managing long-term BH link issue detection according to embodiments of the invention;

FIG. 8 is a schematic and simplified diagram illustrating an exemplary message flow for reporting long-term BH link issue from an IAB-node to an IAB-Donor according to embodiments of the invention;

FIG. 9 illustrates, using a flowchart, an exemplary method, at an IAB node, for managing long-term BH link issue detection according to embodiments of the invention;

FIG. 10 is a block schematic diagram of an example wireless communication device for implementing embodiments of the present invention;

FIG. 11 illustrates, using a flowchart, an exemplary method, at an IAB donor CU, for managing long-term BH link issues according to embodiments of the invention.

### DETAILED DESCRIPTION

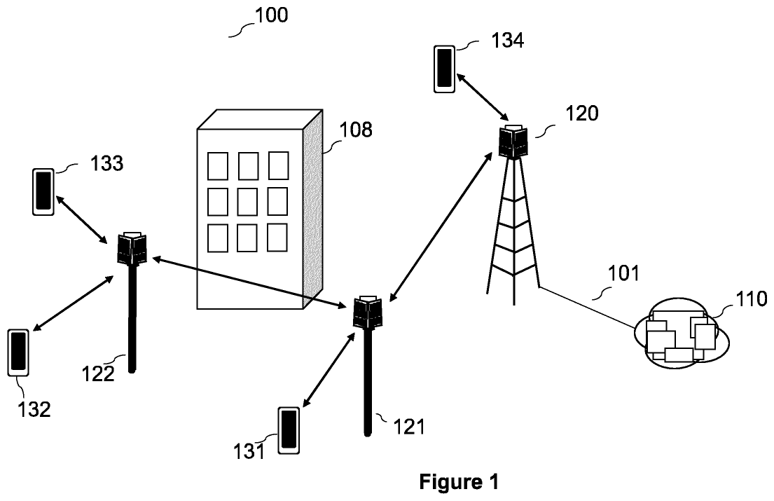

FIG. 1 illustrates an exemplary wireless communication system 100, in particular a mobile radio communication system such as a fifth-generation (5G) New Radio (NR) system including a wireless Integrated Access and Backhaul network. Although in the following description, embodiments and examples of embodiments of the present invention will be described with respect to a 5G NR system, it will be appreciated that it is not intended that the present invention is limited to 5G NR systems and may be used in any wireless communication systems having an integrated access and backhaul network which shares radio resources for wireless access links and wireless backhaul links.

The system 100 comprises a plurality of UEs (User Equipment) 132, 133, 131 and 134, a remote core network 110, a main Base Station 120, and two Integrated Access and Backhaul (IAB) stations or IAB nodes 121 and 122 (also referred to in the following as IAB-nodes).

The main Base Station 120, also referred to as the IAB donor 120 (also referred to in the following as IAB-donor), is connected to the core network 110 through a wired link 101, preferably an optical fiber or any other wired means. In embodiments and examples of embodiments of the invention, IAB-donor 120 is a 5G NR gNB with additional functionality to support IAB features, as defined in 3GPP TS 38.300 v16.2.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The IAB-donor 120 and the IAB-stations 121 and 122 are thus forming a backhaul network or IAB network, which accommodates UEs 132, 133, 131 and 134.

The specification of the Integrated Access and Backhaul (IAB) is spread over several 3GPP standard documents, including:
TS 38.300 RAN architecture (V16.2.0),
TS 38.321 MAC protocol (V16.1.0),
TS 38.331 Radio Resource Control (RRC) protocol (V16.1.0),
TS 38.340 Backhaul Adaptation Protocol Layer (V16.1.0),
TS 38.401 RAN architecture (V16.2.0),
TS 38.473 F1 Application Protocol (V16.2.0).

As IAB-nodes 121 and 122 are respectively connected to UEs 131, 132 and 133, they are considered as Access IAB-nodes for their respectively connected UEs.

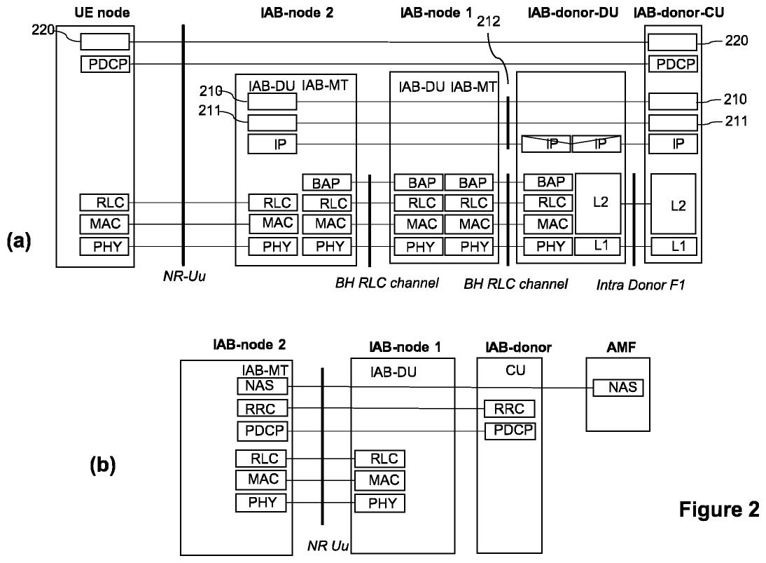

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor CU (also referred to in the following as IAB-donor CU) hosts higher layer protocols, such as PDCP (Packet Data Convergence Protocol) and RRC (Radio Resource Control) protocols, for controlling operation of one or more DUs and each of the one or more IAB-donor-DUs or donor DUs (also referred to in the following as IAB-donor DU) includes lower layer protocols, such as the RLC, MAC and physical layer protocols. The IAB-donor CU or donor CU and IAB-donor DU or donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality as shown in FIGS. 2a and 2b discussed below.

The IAB nodes, which may serve multiple radio sectors, are wireless backhauled to the IAB-donor 120, via one or multiple hops over intermediate IAB nodes. They form a directed acyclic graph (DAG) topology with the IAB-donor at its root.

The IAB nodes consist of an IAB-DU (also referred to in the following as IAB DU) and an IAB-MT (IAB-Mobile Termination) (also referred to in the following as IAB MT). The gNB-DU functionality on an IAB-node is also referred to as IAB-DU and allows the downstream (toward the UE) connection to the next-hop IAB. The IAB-MT functionality includes, e.g., physical layer, layer-2, RRC and Non Access Stratum (NAS) functionalities to connect to the gNB-DU of an upstream IAB-node (including the IAB-donor 120 in which case it connects to the IAB-donor gNB-CU, hence to the core network 110, for instance for initialization, registration and configuration).

In this DAG topology, the neighbour node on the IAB-DU's interface is referred to as child node and the neighbour node on the IAB-MT's interface is referred to as parent node. The direction toward the child node is further referred to as downstream while the direction toward the parent node is referred to as upstream.

The IAB-donor 120 performs centralized resource, topology and route management for the whole IAB topology. This includes configuring the IAB-nodes according to the network topology, e.g. in order to perform appropriate routing of data packets.

FIGS. 2a and 2b schematically illustrate stacks of some protocol layers involved in IAB operations.

F1 interface supports the exchange of signalling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor-CU and an IAB-node-DU (e.g. DU of IAB-node 2), and between the IAB-donor-CU and an IAB-donor DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node 1 and then from IAB-nodel to IAB-node 2).

In the User Plane, boxes 210 at the IAB-donor CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signalling messages between a given pair of GTP-U Tunnel Endpoints (refer to 3GPP TS 29.281 for more details), here boxes 210 at the IAB-donor CU and the IAB-node DU. The well-known User Datagram Protocol (UDP) is a transport layer protocol providing a best effort datagram service and fit to use with an IP protocol.

In the Control Plane, boxes 210 indicate the F1-AP (F1 Application Protocol) layer and boxes 211 indicate the SCTP (Stream Control Transmission Protocol) layer. The F1 Application Protocol (as defined in 3GPP TS38.473 and TS 38.401) provides signalling services between the IAB-donor CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor CU and the IAB-node DU as defined in 3GPP TS 38.401.

The transport between the IAB-donor DU and the IAB-donor CU also uses an IP transport Layer over various media, like for example wires or optical fiber when the IAB-donor CU is remote from the IAB-donor DU, or locally in a virtual instantiation of the IAB-donor CU and the IAB-donor DU on the same physical machine. IAB-specific transport between IAB-donor-CU and IAB-donor-DU is specified in 3GPP TS 38.401.

L1 and L2 on the FIG. 2 stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

The IAB-DU's IP traffic is routed over the wireless backhaul via the BAP sublayer. In a downstream direction, upper layer packets are encapsulated by the BAP sublayer at the IAB-donor DU, thus forming BAP packets or packet data units (PDUs) or data packets. The BAP packets are routed by the BAP layer or entity (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended for a UE).

In upstream direction, upper layer packets are encapsulated by the BAP sublayer at an initiator IAB-node (which may be an access IAB-node should the upper layer packets come from a UE), thus forming BAP packets or data units (PDUs) or data packets. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

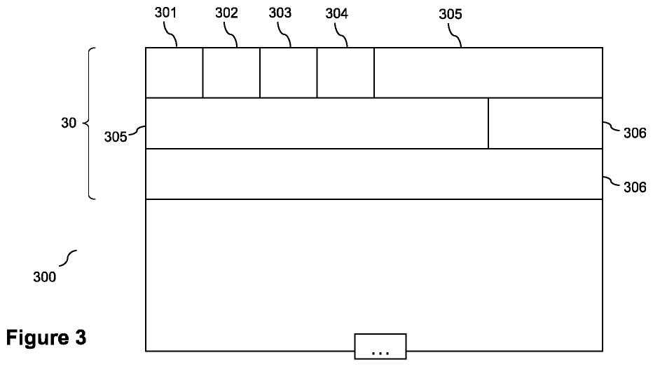

On the BAP sublayer, packets are routed based on the BAP routing ID, which is carried in the BAP header of the BAP packets, and which is set by the BAP sublayer of the emitting IAB-donor-DU or initiator IAB-node (e.g. a network node in the IAB network generating the BAP packets). FIG. 3 illustrates the format of a BAP Data Protocol Data Unit (PDU) or packet. It is specified in the standardized version paragraph 6.2 of 3GPP TS38.340 release 16.3.0.

The payload section 307 is usually an IP packet. The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor DU for the BAP packet. For the purpose of routing, each IAB-node and IAB-donor DU in an IAB network is configured (by IAB-donor CU of the IAB network) with a designated and unique BAP address. Field 306 carries a path ID identifying the routing path the BAP packet should follow to this destination in the IAB topology. For the purpose of routing, the routing paths, including their path ID, are configured (by IAB-donor-CU of the IAB network) in the IAB-nodes.

The BAP header is added to the packet when it arrives from upper layers to the BAP layer, and it is stripped off by the BAP layer when it has reached its destination node. The selection of the packet's BAP routing ID is configured by the IAB-donor-CU.

For instance, when the BAP packet is generated by a node, i.e. either by the IAB-donor-DU for downstream transmission or by an initiator (which may be an access IAB-node should the upper layer packets come from a UE) for upstream transmission, the BAP header with the BAP Routing ID is built by this node according to a configuration table defined in 3GPP TS 38.340. This table is called Downlink Traffic to Routing ID Mapping Configuration table in the IAB-donor-DU or Uplink Traffic to Routing ID) Mapping Configuration table in the initiator IAB-node. In intermediate IAB-nodes, the BAP header fields are already specified in the BAP packet to forward.

As mentioned above, these configuration tables defining the BAP paths (hence the routing strategy and the configuration of the IAB-nodes given the IAB network topology) are usually defined by the IAB-donor-CU and transmitted to the IAB-nodes to configure them.

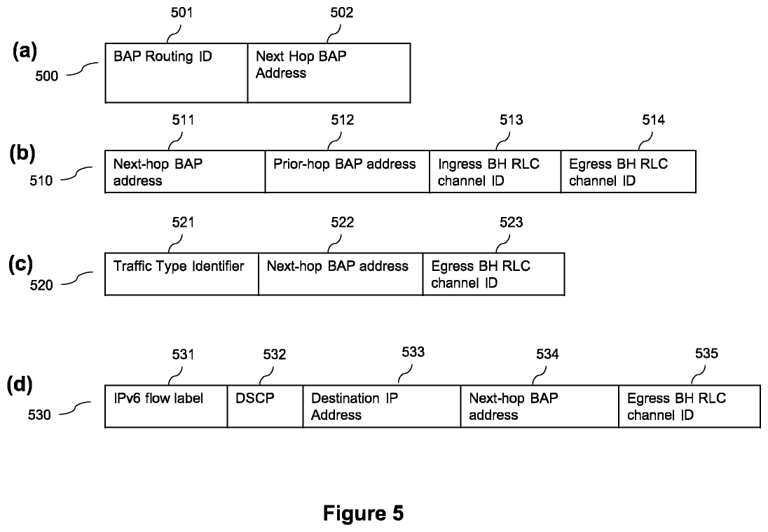

A usage of these tables (and other tables) to perform the routing is described below with reference to FIG. 5.

To transport messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS38.322. The MAC (Media Access Channel) protocol sublayer is responsible for selecting available transmission formats for the user data and for the mapping of logical channel to the transport channels. The MAC handles also a part of the Hybrid Automated Repetition request scheme. The MAC layer is detailed in TS 38.321. On the emitter or transmitter side, the MAC encapsulates the data packet issued from the RLC. It adds a header carrying information necessary to the MAC function. On the receiver side, the MAC decapsulates the data packet issued from the PHY, deletes its header and passes the remaining data to the RLC. The PHY sublayer provides an electrical interface to the transmission medium (the air) by converting the stream of information into physical modulation signals, modulating a carrier frequency at emitter side; at receiver side it converts the physical modulation signals back to a stream of information. The PHY layer is described in TS 38.201, TS 38.211, TS 38.212, TS 38.213, TS 38.214.

To pass messages towards the user or control plane, two other sublayers are used in UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

PDCP sublayer handles The IP Header compression/decompression, ciphering/deciphering, and handles the integrity on the data packet if necessary. It mandatorily numbers the packets on the emitter side and reorders the packets on the receiver side. The PDCP sublayer is described in 3GPP TS38.323.

SDAP sublayer 220 for the User Plane handles the Quality of Service. It is described in TS38.324. On the UE side, the SDAP sublayer exchanges the payload data with the user's application (voice, video, etc . . . —not shown in the FIG. 2). On the IAB-donor CU side, the SDAP sublayer exchanges the data with the Core Network 110 (Internet traffic, Cloud, etc.).

RRC sublayer 220 for the Control Plane handles the configuration of the protocol entities of the User Plane protocol stack. It is described in TS38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 v16.4.0 and illustrates the protocol stack for the support of IAB-MT's RRC and NAS connections. The Non-Access Stratum (NAS) protocol handles the messages between the core network and a user equipment, or an IAB-node. It manages the establishment of communication sessions and maintains communications with the IAB-node or the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes signalling Radio Bearers SRBs (bearers carrying RRC and NAS messages) with the IAB-donor-CU. These SRBs are transported between the IAB-MT and its parent node(s) over NR-Uu interface(s).

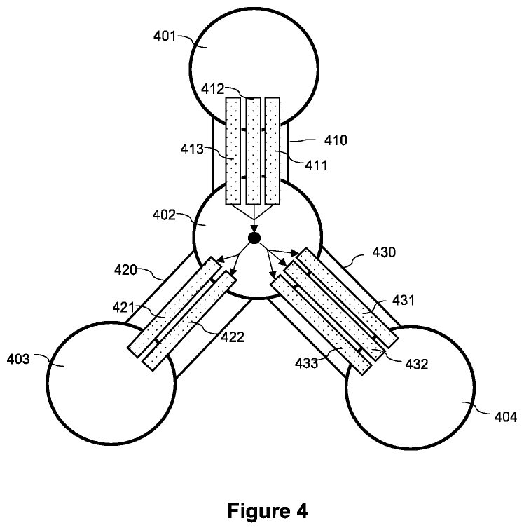

FIG. 4 illustrates a routing management in an IAB network. The routing management at an IAB-node acting as relay is based on a BAP routing configuration and seeks to determine, from one BH RLC channel of an ingress link or backhaul link over which a BAP packet is received, one BH RLC channel of one egress link or backhaul link for forwarding the received BAP packet.

A BAP routing configuration may be set manually in each IAB-node of the IAB network. Preferably, the BAP routing configurations are built and can be updated over time by IAB-donor CU and transmitted by the IAB-donor CU via F1-AP signaling to the IAB-nodes during their initial configurations and the life of the IAB network. As mentioned above, the BAP routing configurations may be built by IAB-donor-CU based on the IAB network topology and its evolution over time (e.g. should some radio links disappear or recover or their link quality changes).

The BAP routing configuration of the IAB-node comprises various routing tables, four of which are shown in FIG. 5.

FIG. 5a schematically shows an entry 500 of the Backhaul Routing Configuration table as defined in 3GPP TS 38.300, V16.4.0, section 6.11.3 for the BAP sublayer. It is used by the IAB-node to select the egress link to forward or transmit a BAP packet or PDU (Protocol Data Unit).

Field 501 defines a BAP Routing ID (concatenation of the PATH field 306 and DESTINATION field 305 as defined in FIG. 3) while field 502 specifies the next-hop BAP Address, i.e. the BAP address of the next IAB-node along the path corresponding to the Routing ID 501. The Next Hop BAP address 502 thus identifies an egress link or backhaul link to forward or transmit the BAP packet.

There may be several entries in the Backhaul Routing Configuration table with the same destination BAP address but with different Path IDs and next-hop BAP Addresses in the information element 502. The first entry may provide the default next-hop BAP Address corresponding to the default path to reach the destination, and the other entries with the same destination BAP address relate to back-up redundant paths to be selected when the default link is not available, e.g. because of radio link failure (RLF) or congestion associated with the link.

FIG. 5b schematically shows an entry 510 of the BH RIC′ channel mapping configuration table as defined in 3GPP TS 38.300, section 6.11.3 and/or 3GPP TS 38.340, V16.3.0, section 5.2.1.4.1, for the BAP sublayer. It is used by the IAB-node acting as a relay (e.g. an intermediate IAB-node) to identify the Backhaul (BH) RLC channel where to forward a BAP packet or PDU over the egress link previously selected using the Backhaul Routing Configuration table.

Information Element (IE) 511 stores a next-hop BAP address as defined previously and usually obtained from the Backhaul Routing Configuration table; IE 512 stores a prior-hop BAP address, i.e. the BAP address of the previous IAB-node from which the BAP packet arrives; IE 513 specifies an ingress RLC channel ID, i.e. the identifier of an RLC channel over which the BAP packet is received; and IE 514 stores an egress RLC channel ID providing the RLC channel the IAB-node will use to forward the BAP packet.

Note that for BH RLC channels in downstream direction (parent to child direction, e.g. IAB-node 402 towards IAB-node 403 in FIG. 4), the BH RLC channel ID is included in the F1-AP configuration of the BH RLC channel. For BH RLC channels in upstream direction (child to parent direction, e.g. IAB-node 402 towards IAB-node 401), the BH RLC channel ID is included in the RRC configuration of the corresponding logical channel.

FIGS. 5c and 5d illustrates the equivalents to the BH RLC channel mapping configuration table for the IAB-node that does not act as intermediate IAB relaying entities. They are defined in 3GPP TS 38.340, sections 5.2.1.4.2. and section 5.2.1.4.3.

The table in FIG. 5c is called Uplink Traffic to BH RLC Channel Mapping Configuration table, 520. It is used by an initiator IAB-node (not the IAB-donor-DU) having built BAP packets or PDUs from BAP SDUs (Service Data Unit) received from upper layers, to identify the Backhaul (BH) RLC channel to transmit these packets in upstream direction over the egress link previously selected using the Backhaul Routing Configuration table described in FIG. 5a.

IE 521 specifies a Traffic Type Identifier for the SDUs received from the upper layers, IE 522 indicates a next-hop BAP address as defined previously and usually obtained from the Backhaul Routing Configuration table, and IE 523 specifies an egress BH RLC channel providing the RLC channel the IAB-node will use to transmit the BAP packet.

The table in FIG. 5d is called Downlink Traffic to BH RLC Channel Mapping Configuration table 530. It is used by the IAB-donor-DU having built BAP packets or PDUs from BAP SDUs (Service Data Unit) received from upper layers, to identify the Backhaul (BH) RLC channel to transmit these BAP packets in downstream direction over the egress link previously selected using the Backhaul Routing Configuration table.

IE 531 is an IPV6 flow label used to classify IPV6 flows, IE 532 specifies a DSCP (Differentiated Services Code Point) usually indicated in the IPV6 header of the packets, IE 533 indicates a destination IP Address, IE 534 indicates a next-hop BAP Address as defined above, and IE 535 defines an egress BH RLC channel ID providing the RLC channel the IAB-node will use to transmit the BAP packet.

The tables of FIGS. 5b, 5c and 5d may be composed of several rows (entries), each row/entry including the IEs (or fields) shown in the respective Figures.

Next-hop BAP address and egress link are synonymous because they designate the same portion (backhaul link) of the IAB network between the current IAB-node and the next IAB-node having the next-hop BAP address. Consequently, they can be used interchangeably to designate such IAB network link.

As a result of all the tables configured in the IAB-nodes and more particularly the Routing IDs of IEs 501, multiple BAP paths are defined through multiple IAB-nodes.

Back to FIG. 4, typically the routing of a BAP packet by the BAP sublayer of IAB-node 402 uses the BAP routing ID 305+306 of a BAP packet. The BAP address (DESTINATION path 305) is used for the purpose of:

1) determining whether the BAP packet has reached the destination node, i.e. IAB-node or IAB-donor DU, on BAP sublayer. The BAP packet has reached its destination node if the BAP address 305 in the packet's BAP header matches the BAP address configured either via RRC on the IAB-node or via F1-AP on the IAB-donor DU.

2) determining the next-hop IAB-node for the BAP packet that has not reached its destination. This applies to BAP packets arriving from a prior-hop IAB-node over the BAP sublayer or that have been received from upper layers.

For packets arriving from a prior-hop IAB-node or from upper layers, the determination of the next-hop IBA-node is based on the Backhaul Routing Configuration table 500.

The IAB-node 402 resolves the next-hop BAP address 502 to a physical backhaul link, being either link 420 or link 430. To that end, it seeks the entry in the table 500 having field 501 matching the BAP Routing ID 305+306 of the BAP packet. Corresponding field 502 provides the next-hop BAP address.

The Backhaul Routing Configuration table may have multiple entries 500 with different BAP Routing IDs but with the same destination BAP address (meaning the BAP Path IDs are different). These entries may correspond to the same or different egress BH links. In case, the BH link matching the BAP Routing ID of the BAP packet experiences a radio link failure (RLF), typically the IAB-node may select another egress BH link (next-hop BAP address) based on routing entries with the same destination BAP address, i.e. by disregarding the BAP path ID. In this manner, a BAP packet can be delivered via an alternative path in case the indicated path is not available.

For instance, in case BH link 420 experiences a radio link failure, IAB-node 402 may select another BAP routing ID having the same destination BAP address but involving BH link 430 instead.

Next, the IAB-node 402 derives the egress BH RLC channel of the selected egress BH link, over which the BAP packet is to be transmitted or forwarded. To that end, the IAB-node 402 uses the BH RLC channel mapping configuration table or Uplink Traffic to BH RLC Channel Mapping Configuration table or Downlink Traffic to BH RLC Channel Mapping Configuration table depending on its role (intermediate or relay IAB-node, initiator IAB-node or IAB-donor-DU transmitting in uplink/upstream or downlink/downstream direction).

For instance, for an intermediate or relay IAB-node, IEs 511, 512, 513 are the inputs and IE 514 is the output of the BH RLC channel look-up process: IAB-node 402 routes the incoming BAP packets received from the ingress BH RLC channel ID 513, belonging to the ingress BH link identified by the prior-hop BAP address 512, to the egress BH RLC channel ID 514, belonging to the egress BH link previously selected and now identified by the next-hop BAP address 511.

For an initiator IAB-node wishing to transmit a BAP packet in the upstream direction to the IAB-donor, IEs 521, 522 are the inputs and IE 523 is the output of the BH RLC channel look-up process: the IAB-node 402 selects the egress BH RLC Channel 523 corresponding to the table entry 520 where the Traffic Type Identifier 521 matches the traffic type of the original BAP SDU, and where the next-hop BAP address 522 matches the next-hop BAP address previously selected with the Backhaul Routing Configuration table. This applies for BAP SDUs in the control plane (non F1-U packets), as well as for BAP SDUs in the user plane (F1-U packets). The Traffic Type Identifier 521 shall correspond to the destination IP address and TEID (Tunnel End Point Identifier) of the BAP SDUs.

For the IAB-donor-DU wishing to transmit a BAP packet in the downstream direction to a destination IAB-node or an UE, IEs 531, 532, 533, 534 are the inputs and IE 535 is the output of the BH RLC channel look-up process: IAB-node selects the egress BH RLC Channel 535 corresponding to the table entry 530 matching the Destination IP address 533, the IPV6 Flow Label 531 (only for BAP SDU encapsulating an IPV6 packet), and the Differentiated Services Code Point (DSCP) 532 of the original BAP SDU, and where the next-hop BAP address 534 matches the next-hop BAP address previously selected with the Backhaul Routing Configuration table. This applies for BAP SDUs in the control plane (non F1-U packets), as well as for BAP SDUs in the user plane (F1-U packets).

If there is no matching entry, a default BH RLC ID channel may be selected.

Such routing process can be implemented in the various IAB-nodes of an IAB network.

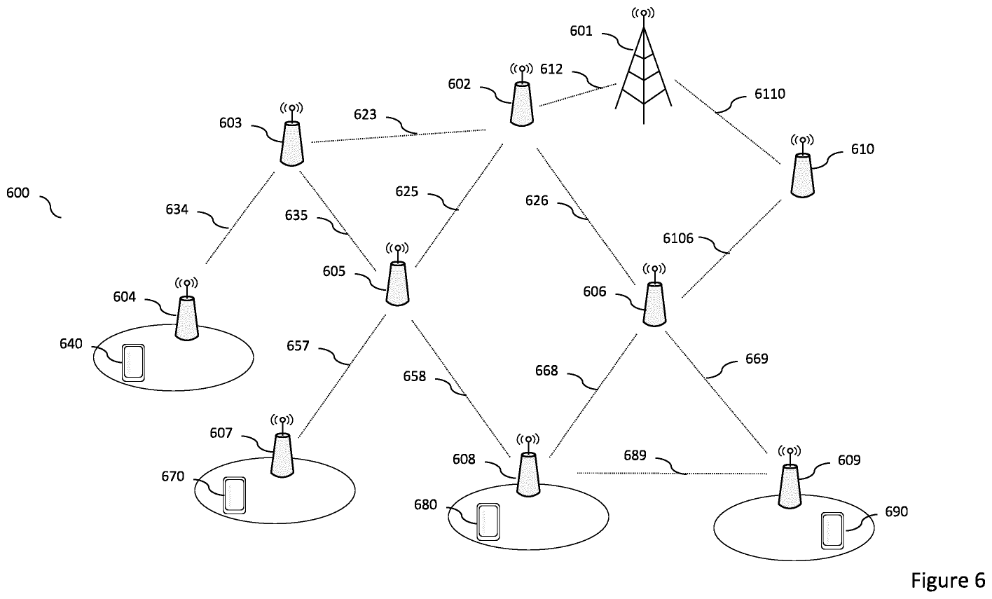

FIG. 6 illustrates an example topology of an IAB network 600 providing network path diversity in which embodiments and examples of embodiments of the present invention may be implemented. In one example implementation, the BH radio links are operated over the millimeter wave frequency band (i.e. above 30 GHz), which is highly sensitive to radio channel disturbance.

IAB network 600 comprises one IAB-donor 601, similar to IAB-donor 120 of FIG. 1, and a plurality of IAB-nodes 602, 603, 604, 605, 606, 607, 608, 609 and 610, similar to IAB-nodes 121 and 122 of FIG. 1. These IAB-nodes are connected through backhaul (BH) links 612, 6110, 623, 625, 626, 634, 635, 657, 658, 668, 669, 689 and 6106 (also referred to as BH radio links).

As IAB-nodes 604, 607, 608 and 609 are respectively serving UEs 640, 670, 680 and 690, they also act as access IAB-nodes for the respective UEs.

Redundant paths may exist between pairs of IAB-nodes. For instance, paths between IAB-donor 601 and IAB-node 608 include a first default BAP path via IAB-nodes 602, 605 and 608, a second BAP path that involves IAB-nodes 602, 603, 605 and 608, and a third BAP path that involves IAB-nodes 602, 606 and 608.

For the exemplary description below, the following BAP paths are considered:
PATH 1, associated with Routing ID 1, which connects IAB-node 608 to IAB-donor 601 via IAB-nodes 605, 602 and goes through BH radio links 658, 625 and 612. This may be the default path between 601 and 608;
PATH 2, associated with Routing ID 2, which connects IAB-node 608 to IAB-donor 601 via IAB-nodes 605, 603, 602 and goes through BH radio links 658, 635, 623 and 612;
PATH 3, associated with Routing ID 3, which connects IAB-node 608 to IAB-donor 601 via IAB-nodes 606, 602 and goes through BH radio links 668, 626 and 612.

BH radio link 625 between IAB-nodes 602 and 605 may experience radio link deficiency (e.g. deficiency in the link quality) due to some unexpected interference or shadowing phenomena, for example radio link failure, RLF. When the radio link deficiency (link quality) reaches or is less than an RLF threshold such that RLF is detected, the default BAP path PATH 1 may thus become unavailable between IAB-nodes 601 and 608. Only the second and third paths, PATH 2 and PATH 3, may then be used as alternative re-routing paths.

As explained above, IAB-node 605 can detect the radio link deficiency of a BH radio link. IAB-node 605 is therefore a detecting IAB-node. More precisely, the IAB-MT of IAB-node 605 can detect radio link deficiency of BH radio link 625 (and also link 635). It may warn its child IAB-nodes, namely IAB-nodes 607 and 608, of the radio link deficiency using a BH RLF indication message. The BH RLF indication message can also be forwarded by a child IAB-node to its own child IAB-nodes, if it has any.

The following types BH RLF indication message may be considered:
Type 2 BH RLF indication message is sent by the detecting IAB-node as soon as an RLF is detected on one of its BH links;
Type 3 BH RLF indication message is sent by the detecting IAB-node upon recovery of an RLF on one of its BH links;
Type 4 BH RLF indication message is sent by the detecting IAB-node upon detection of an RLF recovery failure, as defined in TS38.340. RLF recovery failure may indicate an IAB-node's failure to recover from RLF.

In one aspect of the invention as discussed in more detail below, the detection of RLF may also be performed by the IAB-DU of an IAB-node (e.g. the IAB-DU of IAB-node 605 can detect radio link deficiency of BH radio links 657 and 658).

Thus, in an example when the BH link 625 experiences a radio link failure (RLF) and PATH 1 is not available, PATH 2 or PATH 3 may be used as an alternative path. For example, the IAB-node 605 may select PATH 2 as an alternative path for routing a BAP packet to IAB-donor 601 in which case the IAB-node 605 may select BH link 635 as another egress BH link (next-hop BAP address) based on routing entries in the Backhaul Routing Configuration table with the same destination BAP address of IAB-donor 601, i.e. by disregarding the BAP path ID. In this manner, a BAP packet can be delivered via PATH 2 as an alternative path when PATH 1 is not available.

As discussed above, each IAB-node includes an IAB-DU and an IAB-MT. Each of the IAB-MT and the IAB-DU of a IAB-node includes a buffer (for example, implemented in the BAP layer or entity) for buffering data (e.g. BAP packets or PDUs) to be routed between nodes in the IAB network node. When the buffer load (e.g. an amount of data buffered in the buffer) exceeds or reaches a certain level (also referred to as congestion threshold) or overflows, a congestion issue or problem at the IAB-node is detected. The IAB-MT or the IAB-DU may detect there is a congestion issue depending on whether the affected backhaul link is coupled to a parent IAB-node or a child IAB-node. Thus, an IAB-node, such as IAB-node 608, may experience congestion at its own buffer level (e.g. at the IAB-DU buffer). Therefore, when its buffer load exceeds or reaches a certain level, IAB-node 608 may warn its parent node, i.e. IAB-node 605, that congestion at the IAB-node 608 has been detected by sending a flow control feedback message, as defined in TS38.340. IAB-node 608 may also send a flow control feedback message to IAB-node 605 once having received from IAB-node 605 a flow control polling message. The flow control feedback message typically includes information indicating the available buffer size at the IAB node. Thus, the information in the flow control feedback message can provide an indication when the buffer load of the IAB-DU or the IAB-MT of an IAB-node exceeds or reaches a certain level and thus, can provide an indication of a congestion problem or issue associated with a backhaul link (e.g. congestion affecting transmission of data over the backhaul link). It will be appreciated that congestion associated with a backhaul link may result from too much data to be routed over the backhaul link, for example due to re-routing of data from other IAB-nodes, or may result from too much data to be routed over the backhaul link due to the link quality of the backhaul link decreasing which decreases the link capacity or maximum throughput of the backhaul link (e.g. the amount of data that can be routed or transmitted over the backhaul link is decreased due to a reduction in the link quality).

The BAP entity of the IAB-DU of an IAB node may comprise at least one buffer (typically one buffer per RLC channel) for receiving BAP PDUs from the BAP entity of the IAB-MT of the IAB node to be transmitted to a child IAB node over a backhaul link (for communication in the downstream direction) and for receiving BAP PDUs from the child IAB node to be transmitted to the BAP entity of the IAB-MT of the IAB node (for communication in the upstream direction). Similarly, the BAP entity of the IAB-MT of an IAB node comprises at least one buffer (typically one buffer per RLC channel) for receiving BAP PDUs from the BAP entity of the IAB-DU of the IAB node to be transmitted to a parent IAB node, which may be a IAB-donor DU, over a backhaul link (for communication in the upstream direction) and for receiving PDUs from the parent IAB node (which may be a IAB-donor DU) to be transmitted to the BAP entity of the IAB-DU of the IAB node (for communication in the downstream direction). When the buffer load of a buffer of the BAP entity (of the IAB-DU or the IAB-MT) of an IAB-node exceeds a certain level (e.g. the number of data units in the buffer exceeds a certain level), or in response to a flow control polling message received at the IAB-MT of the IAB node from a IAB-node (such as the parent node), the BAP entity (of the IAB-DU or the IAB-MT) generates and sends a flow control feedback message to the IAB-node which includes information indicating the available buffer size at the BAP entity of the IAB-MT and/or the IAB-DU. Thus, the information in the flow control feedback message provides an indication when the buffer load of a buffer of the BAP entity (of the IAB-DU or the IAB-MT) of an IAB-node exceeds a certain level and thus, provides an indication of a problem or issue of congestion associated with a backhaul link.

Following detection at a IAB-node of a RLF issue of a backhaul link, the IAB node (referred to as the local IAB node) may perform local action(s), such as local re-routing (e.g. performed by a BAP entity of the IAB node) so that data can be re-routed to the destination IAB node, so as to minimize the impact of the RLF issue. Furthermore, following the detection of the RLF issue, radio conditions may improve which result in the radio link quality level for the backhaul link increasing. Once the radio link quality reaches or exceeds a RLF recovery threshold, the IAB-node may consider the backhaul link as being recovered (e.g. the RLF issue has been recovered and no longer exists). The IAB-node can then send a Type 3 BH RLF indication message for the recovered BH link and can start to use again the backhaul link again to route data.

Similarly, following detection at an IAB-node of a congestion issue for transmission of data over a backhaul link, the IAB node may perform local action(s), such as local re-routing or load balancing (e.g. performed by a BAP entity of the IAB node), and/or bitrate adaptation (e.g. performed at a scheduler in the IAB node), and/or buffering and queue management, so as to minimize the impact of the congestion issue. Furthermore, following the detection of the congestion issue, radio conditions/link quality may improve and/or local actions may be performed at the IAB-node as indicated above, which results in congestion at the IAB-node decreasing. Once the buffer load at the IAB-node reaches or is less than a recovery level (also referred to a congestion recovery threshold), the IAB-node may consider the backhaul link as being recovered (e.g. the congestion issue has been recovered and no longer exists). The IAB-node can then if desired, or in response to a flow control polling message, send a flow control feedback message including information indicating the congestion issue has been recovered (e.g. based on the available buffer size indicated in the flow control feedback message).

Since the local IAB node does not have the knowledge of the configuration or link issue status of all the nodes in the IAB network, local action(s) in handling the RLF/congestion issue may create link issues at some other IAB nodes (e.g. remote to the local IAB node) in the IAB network and thus, any such local action(s) should preferably be applied for a limited time period.

It may take a short time to recover from the RLF or congestion issue (e.g. due to quick recovery of link quality) and so for these short-term or transient link issues, local action at the IAB node, such as local re-routing for RLF issues, local re-routing or load balancing and/or bitrate adaptation for congestion issues, can provide an efficient means to reduce or mitigate the impact of the link issue and since they are only needed for a short time period the impact on other nodes in the IAB network is minimized. However, for some link issues (referred to as long-term link issues), such as recurring or repeating or successive link issues or long-lasting link issues that take a long time to be recovered from or link issues that cannot be recovered, taking local action at the local IAB-node (e.g. local re-routing or load balancing etc.) may have a significant impact on other nodes in the IAB network, such as creating link issues at the other nodes. Such long-term link issues are thus link issues which require the IAB-donor CU to reconfigure the routing configuration of all or some of the IAB-nodes in the IAB network, as the IAB-donor CU is the only node having the knowledge of the whole IAB network topology.

Techniques for differentiating, at a IAB-node, a long-term link issue, which requires reconfiguration by the donor CU (or IAB-donor CU) of routing configuration in the IAB network, from a short-term link issue, which can be addressed locally at the IAB-node, according to some embodiments and examples of the present invention and how the IAB node notifies the donor CU (or IAB-donor CU) of a long-term link issue according to some embodiments and examples of the present invention are now described.

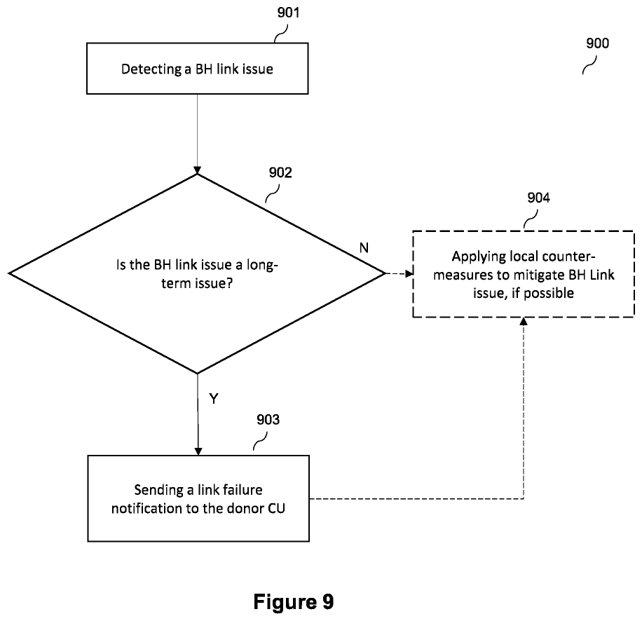

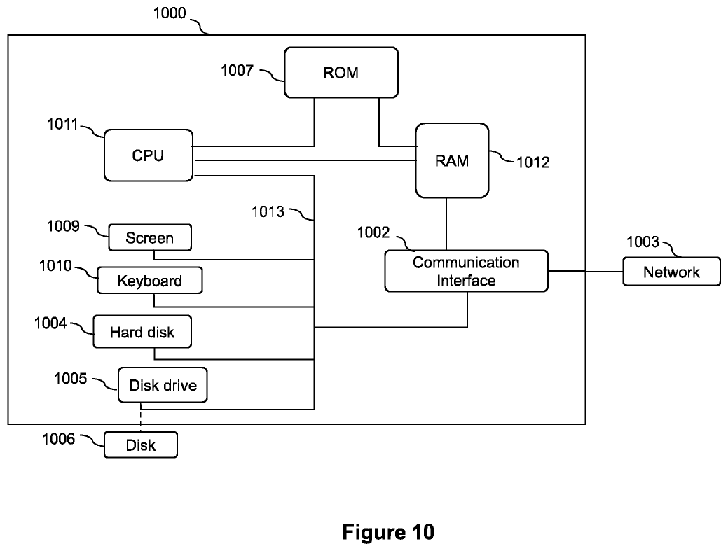

FIG. 9 shows steps of a method 900 performed at a IAB node (also referred to as IAB-node) in accordance with an embodiment of the present invention. The IAB node is part of an IAB network comprising a plurality of IAB nodes and a donor CU (also referred to as IAB-donor CU) which is part of a IAB donor in the IAB network. With reference to FIG. 1, the IAB node may be node 121 and the donor CU may be node 120. With reference to FIG. 6, the IAB node may be node 605 of IAB network 600 and the donor CU may be node 601. The IAB node may be implemented in a communication device 1000 as shown in FIG. 10 below with the method as described with reference to FIG. 9 being performed by the central processing unit 1011. The method may be performed at the Mobile Termination (MT) of the IAB node or at the Distributed Unit (DU) of the IAB node. For example, a program element executed by the CPU 1011 of FIG. 10 for implementing a BAP entity (DU or MT part) of the BAP sublayer may perform the method as described with reference to FIG. 9. The method of FIG. 9 may be applied for upstream or downstream communication directions.

An IAB-node (e.g. node 605 in FIG. 6) detects a link issue or link problem (also referred to as a BH link issue) for transmission of data over a backhaul link (also referred to as BH link or BH radio link) of the IAB network, at step 901. The link issue may be associated with a BH link between the IAB-node 605 and a parent IAB-node (such as IAB-node 602 so that the affected BH link is BH link 625) or may be associated with a BH link between the IAB-node 605 and a child IAB-node (such as IAB-node 607 so that the affected BH link is BH link 657) or may be associated with a BH link between a parent or child IAB-node of IAB-node 605 and another IAB-node (such as the BH link 623 between parent IAB-node 603 and IAB-node 602 or the BH link 689 between child IAB-node 608 and IAB-node 609). In the latter case, IAB-node 605 may determine there is a link issue with BH link 623 based on information (such as a RLF indication message or flow control feedback message) relayed to the IAB-node 605 from the parent or child IAB-node. The link issue or BH link issue (e.g. the type of the link issue or the BH link issue) may be a Radio Link Failure, RLF, of the backhaul link or congestion affecting transmission of data over the backhaul link. For example, the congestion may be at the IAB-node or an IAB-node connected to the IAB node, which may impact the backhaul link or one or more other BH links. In other words, the link issue or link problem relates to an issue or problem that affects (negatively) the transmission of data over the BH link. A cause or source of the link issue or link problem may be at least one of: 1) link quality, or 2) an amount of data to transmit over a backhaul link, or 3) radio link recovery failure, or 4) recurring link issues, or 5) links issues that take too long to recover from, etc.

In response to detecting the link issue, the IAB-node 605, sends a link failure notification to the donor CU (or IAB-donor CU). For example, at step 902, the IAB-node 605 determines whether the link issue provides a long-term link issue (e.g. or a short-term (ie. Transient) link issue). A long-term link issue requires reconfiguration by the donor CU (or IAB-donor CU) of routing configuration in the IAB network (e.g. some or all of the IAB nodes in the IAB network) whereas a short-term link issue is handled locally at the IAB-node. For example, a long-term link issue is a recurring or repeating or successive link issue or long-lasting link issue that takes a long time to be recovered from or a link issue that cannot be recovered. In response to determining the detected link issue provides a long-term link issue, the IAB-node 605, sends a link failure notification to the donor CU, wherein the link failure notification includes link identification information identifying the backhaul link (e.g. the backhaul link affected by the long-term link issue) and link issue information relating to the detected link issue, including information associated with a cause or source of the detected link issue (e.g. the long term link issue), step 903. The information associated with the cause of the link issue may include information indicating the cause of the detected link issue or a type of the cause of the detected link issue. For example, the type of cause of the detected link issue is one of a long-term cause (e.g. resulting in a long-term link issue) or a short-term cause (resulting in a short-term link issue). A long-term cause of the detected link issue may include one of: link recovery failure; slow recovery of link issue; recurring link issues. Short-term causes may include too much data to be transmitted over a backhaul link for only a short period of time (i.e. is recovered from in a short period of time) resulting in congestion as a short-term link issue and/or link quality for a backhaul link being less than a threshold level for only a short period of time (i.e. is recovered from in a short period of time) resulting in Radio Link Failure, RLF, as a short-term link issue.

The IAB-node 605 may determine whether the link issue provides a long-term link issue by determining, based on the detected link issue, whether one of a plurality of predetermined link failure criteria (also referred to as predetermined link issue criteria) is met. Each one of the plurality of predetermined link issue criteria represents a cause or source of or resulting in a long-term link issue so by checking whether one of the predetermined link issue criteria is met (or exists or is present), a long-term link issue can be determined. For example, sending the link failure notification to the donor CU may be in response to determining, based on the detected link issue, a predetermined link issue criterion is met (e.g. the predetermined link issue criterion that is met is one of the plurality of link issue criteria) and link issue information relating to the detected link issue, including information indicating the predetermined link issue criterion determined to have been met.

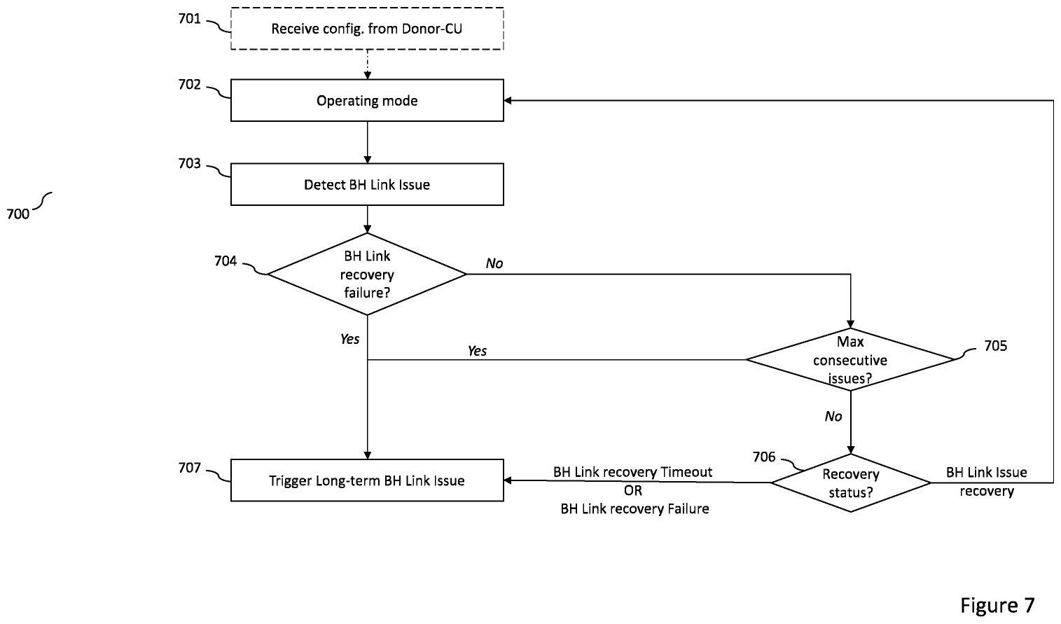

As will be discussed in more detail below with respect to FIG. 7, three causes, or three predetermined link issue criteria, which each result in a long-term link issue may be considered for a long-term link issue:
1) Link recovery failure (RLF failure recovery or congestion that cannot be recovered);
2) Slow link recovery (RLF failure or congestion recovery takes too long e.g. time taken to recover from a link issue is greater than a predetermined threshold);
3) Recurring or repeating link issues—BH link issue repetition (succession or sequence of RLF detection/RLF recovery and/or congestion detection/congestion recovery).

The BH link issue may be detected at either IAB-MT or IAB-DU unit of the IAB-node, while the detection may be performed directly, i.e. the IAB-MT or IAB-DU performs the detection at its own level, or indirectly, the IAB-MT or IAB-DU performs the detection based upon the reception of a BH link issue message from a connected IAB-node. In this respect, it may be advantageous that BH link issue messages (e.g. RLF indication message, Flow Control feedback message) are forwarded by the IAB-nodes.

As discussed above, the link failure notification sent by the IAB-node 605 includes link identification information identifying the backhaul link and link issue information relating to the detected link issue, including information associated with a cause of the long-term link issue (e.g. Long Term BH Link Issue Cause information which indicates the cause for the long-term link issue, such as, link recovery failure, slow link recovery or successive or repeating or recurring BH link issues and/or Long Term BH Link IssueTypeof Cause information which indicates the type of the cause for the long-term link issue, such as, a long-term cause or a short-term cause).

The link identification information or BH Link information may include at least one of:
unique addresses (e.g. the unique BAP addresses) of IAB nodes at both ends of the backhaul link;
cell identifier (e.g. Cell ID) identifying a cell associated with the backhaul link;
RLC channel identifier identifying the RLC channel, in failure or associated with the link issue, of the backhaul link;
BAP routing identifier.

The link issue information in the link failure notification message sent by the IAB-node may, in addition to the information associated with a cause of the long-term link issue, carry all or part of the following information:
The nature of or provided by the BH link issue (e.g. Long-term link issue). For example, Long Term BH Link Issue Indication information for indicating that a long-term failure or link issue has occurred on the BH link identified by the aforementioned BH Link information.
The type of failure or type of link issue, i.e. RLF or congestion. For example, an RIF Indication information for indicating that the long-term failure or link issue results from a BH Radio Link Failure (RLF) and Congestion Indication information for indicating that the long-term failure or link issue results from a congestion phenomenon.
BH Link Quality. For example, Link Quality Information for indicating the quality of the BH link impacted by the BH link issue (e.g. SINR, congestion level . . . ).
Failure ageing (i.e. the time since the issue was detected). For example, Ageing information for providing some timing information related to the instant of detection of the BH link issue. Link issue time information may indicate a time between detecting the link issue and sending the link failure notification.

In an example, the IAB node 605 sends the link failure notification to the donor CU upon detection of the BH link issue.

In an example, the IAB node 605 sends the link failure notification following the reception of a polling request from the Donor CU.

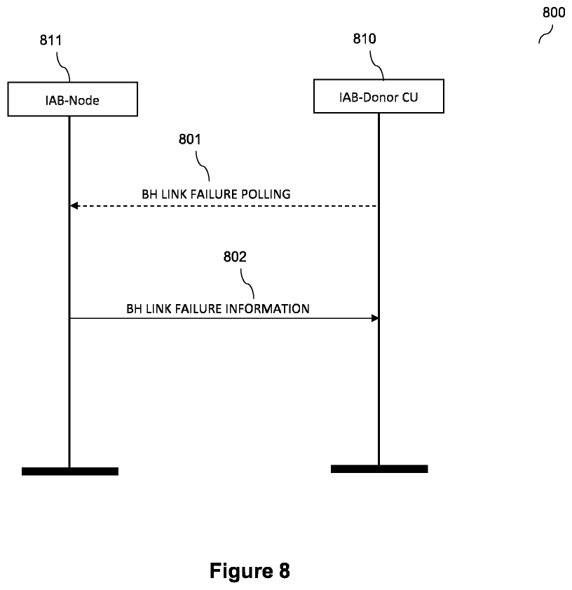

The MT of the IAB-node may send the link failure notification to the donor CU. For example, the MT of the IAB-node may send the link failure notification in a RRC message, such as a UJEInformationResponse message defined in 3GPP TS 38.331 or a MCGFailureInformation message defined in 3GPP TS 38.331. Other examples are given below with reference to FIG. 8.

The DU of the IAB-node may send the link failure notification to the donor CU. For example, the DU of the IAB-node may send the link failure notification in a F1-AP layer message, such as a GNB-DU STATUS INDICATION message defined in 3GPP TS 38.473.

In another example, the DU of the IAB-node may send the link failure notification in a NR user plane protocol frame, such as an ASSISTANCE INFORMATION DATA frame defined in 3GPP TS 38.425. This frame is conveyed by GTP-U protocol means, more specifically, by means of the “NR RAN Container” GTP-U extension header as defined in TS 29.281.

Irrespective of whether the IAB-node 605 detected a long-term or a short-term BH link issue at step 902, it may try to apply local counter-measures or local actions, at step 904, to mitigate the BH link issue, if possible. For instance, the IAB-node 605 may try to mitigate the effects of an RLF or a congestion phenomenon by performing local re-routing, i.e. selecting an alternate routing path, as discussed in FIG. 6, and/or performing some bitrate adaptation and/or load balancing and/or buffering and queue management.

More details as to how the IAB-node may detect a link issue (or BH link issue/problem) for transmission of data over a backhaul link (or BH link) and how the IAB-node may determine whether the detected BH link issue provides a long-term BH link issue will now be described with reference also to FIG. 7 which illustrates, using a flowchart 700, an exemplary method, according to embodiments and examples of the invention, for detecting and managing long-term BH link issues. The method may be performed at the MT of the IAB node or the DU of the IAB node. For instance, a program element executed by the CPU 1011 of FIG. 10 for implementing a BAP entity (DU or MT part) of the BAP sublayer may perform the exemplary method as described with reference to FIG. 7. The method of FIG. 7 may be applied for upstream or downstream communication directions.

An IAB-node, such as IAB node 605 of IAB network 600 of FIG. 6, is configured, at step 701, by the IAB-donor, such as IAB-donor 601, so as to be further capable of differentiating long-term BH link issues from short-term BH link issues once in the operating mode at state 702. The IAB-donor 601 configures IAB-node 605 during an initial configuration process and may also configure or re-configure IAB-node 605 during the life of the IAB network 600. Step 701 is therefore shown in dotted lines in FIG. 7.

In one example, the IAB-donor 601 configures the IAB-node 605 by sending a dedicated Information Element or backhaul link failure configuration information, which is made of all or part of the following information:
A maximum number of consecutive BH link issues, or maxConsecutiveIssues, to be detected by the IAB-node, in relation with steps 705 and 706 of flowchart 700. For example, information indicating a maximum number of detected link issues (e.g. including previously detected link issues) for data transmission over the backhaul link;
A BH link issue recovery time window, or Consecutive IssuesTime Window, (e.g. having a predetermined length) during which a maximum number of consecutive BH link issues may be detected, in relation with step 705 of flowchart 700;
A maximum recovery timeout, or maxRecoveryTimeout, for recovery from a former BH link issue, in relation with step 706 of flowchart 700. For example, recovery timeout information indicating a maximum time period between a time of detection of a link issue and a time of recovery from the detected link issue.

The aforementioned dedicated Information Element may be used by the IAB-donor 601 to configure the IAB-MT unit of an IAB-node (such as IAB-node 605) in the IAB network 600. In one example, the message used to carry this Information Element is the RRCReconfiguration message, as defined in TS38.331 specification.

The aforementioned dedicated Information Element may be used by the IAB-donor 601 to configure the IAB-DU unit of an IAB-node (such as IAB-node 605) in the IAB network 600. In one example, the message used to carry this Information Element is the GNB-CU CONFIGURATION UPDATE message, as defined in 3GPP TS 38.473 specification, or the Access And Mobility Indication message, as defined in 3GPP TS 38.473 specification.

At step 703, the IAB-node (605) detects a BH Link issue. Several different natures or categories of BH link issues may be considered and detected, as discussed below. The different categories may include, for example, different types of BH link issues such as a RLF type of link issue (with RLF of the BH link) or a congestion type of link issue (with congestion affecting transmission of data over the BH link). The different categories may also include different types of BH link issues and how they are detected: e.g. one category is RLF detected via monitoring link quality and another category is RLF detected by a Type 2 RLF indication message. The link issue may be associated with a BH link between the IAB-node 605 and a parent IAB-node (such as IAB-node 602 so that the affected BH link is BH link 625) or may be associated with a BH link between the IAB-node 605 and a child IAB-node (such as IAB-node 607 so that the affected BH link is BH link 657) or may be associated with a BH link between a parent or child IAB-node of IAB-node 605 and another IAB-node (such as the BH link 623 between parent IAB-node 603 and IAB-node 602 or the BH link 689 between child IAB-node 608 and IAB-node 609).

Detecting an RLF link issue for transmission of data over the backhaul link may comprise monitoring link quality (e.g. by the MT or DU of the IAB-node 605) of the backhaul link and when the link quality is less than or reaches a RLF threshold, detecting RLF of the backhaul link. In other words, by monitoring the link quality, the MT or DU of the IAB-node can directly detect an RLF link issue. Additionally or alternatively, detecting a RLF link issue for transmission of data over the backhaul link may comprise receiving at the IAB-node 605 (e.g. at the MT of the IAB-node 605) a RLF indication message associated with the backhaul link and indicating a RLF or RLF recovery failure (e.g. a Type 2 or Type 4 RLF indication message). The RLF indication message may be sent by a parent IAB-node (such as IAB-node 602) or may be an RLF indication message sent by a remote IAB-node (two or more hops away) and forwarded to the IAB-node 605. In other words, in response to the receipt of an RLF indication message, the IAB-node can indirectly detect an RLF link issue.

IAB-node 605 may monitor a state or link quality of the BH radio link 625 through the periodic exchanges of signals (e.g. to tune antennas, negotiate radio power, etc.) at the PHY layer with the IAB-node 602 (and also IAB-nodes 603, 607, 608 for the other BH radio links) connected to IAB-node 605.

In one example, the IAB-MT of the IAB-node 605 detects, at step 703, a BH Radio Link Failure on an ingress BH link with a parent IAB-node (e.g. BH link 625 with parent IAB-node 602) by monitoring the BH link quality.

For instance, the IAB-MT may assume that a BH Radio Link or BH link is broken in the following if the measured Reference Signal Receive Power (RSRP) is below a predefined threshold or if it failed to decode either Physical Downlink Control Channel (PDCCH) or Physical Downlink Shared Channel (PDSCH) due to insufficient power signal quality, e.g. low RSRP or low Reference Signal Receive Quality (RSRQ). The one skilled in the art may find other methods to detect a Radio Link Failure at IAB-MT.

In one example, the IAB-DU of the IAB-node 605 detects, at step 703, a BH Radio Link Failure on an egress BH link with a child IAB-node (e.g. BH link 658 with child IAB-node 608) by monitoring the BH link quality.

For instance, IAB-DU may assume that a BH Radio Link or radio link is broken if the Signal-to-interference-plus-noise ratio (SINR) from the child IAB-MT is below a predefined threshold or if the IAB-DU did not detect any acknowledgement message (e.g no ACK or NACK) from the child IAB-MT over the Physical Downlink Shared Channel (PDSCH) (e.g. it was not received or was received but could not be decoded). The one skilled in the art may find other methods to detect a Radio Link Failure at IAB-DU.

In one example, the IAB-MT of the IAB-node 605 detects, at step 703, a BH Radio Link Failure on the ingress BH link of a parent IAB-node by receiving a Radio Link Failure indication message from said parent IAB-node. In one aspect, this Radio Link Failure indication message may indicate that a BH RLF recovery failure was detected by the IAB-MT of the parent IAB-node (Type-4 RLF indication message). In another aspect, this Radio Link Failure indication message may indicate that a BH RLF was detected by the IAB-MT of the parent IAB-node (Type-2 RLF indication message). In one example, the Radio Link Failure indication message received by the IAB-node 605 was relayed by its parent IAB-node from another IAB-node in the IAB network.

Detecting a congestion link issue for transmission of data over the backhaul link may comprise monitoring (e.g. by the MT or DU of the IAB-node 605) a load of a buffer of the IAB node, the buffer being associated with the backhaul link. When the load exceeds or reaches a congestion threshold, detecting congestion at the buffer and thus, congestion for transmission of data over the backhaul link. Additionally or alternatively, detecting a congestion link issue for transmission of data over the backhaul link may comprise receiving at the IAB-node 605 (e.g. at the MT or DU of the IAB-node 605) a flow control feedback message associated with the backhaul link and indicating congestion affecting transmission of data over the backhaul link, and determining from the flow control feedback message congestion over the backhaul link. Other mechanisms for detecting a congestion link issue or problem at an IAB-node may also be used, such as detecting packet delay.

In one example, the IAB-MT of the IAB-node 605 detects, at step 703, some congestion resulting from a local buffer load exceeding a certain level.

In one example, the IAB-DU of the IAB-node 605 detects, at step 703, some congestion at a child IAB-MT of a child IAB-node (such as IAB-node 608), by receiving a flow control feedback message from said child IAB-MT, which indicates that the buffer load at IAB-MT is exceeding a certain level. In one example, the flow control feedback message received by the IAB-node (e.g. at the IAB-MT) was relayed by its child IAB-node (such as IAB-node 608).

In one example, the flow control feedback message received by the IAB-node was sent by its parent IAB node (such as IAB-node 603).

The one skilled in the art may find other methods to detect congestion at the IAB-DU and/or IAB-MT.

The IAB-node 605 then determines whether the detected link issue provides a long-term link issue via steps 704, 705 and 706. For example, the IAB-node 605 checks for the cause of the detected link issue to determine whether the cause is a long-term cause.

At step 704, the IAB-node 605 checks whether the detected BH link issue is related to a BH link recovery failure.

In one example, the BH link recovery failure relates to the detection by the MT unit of the IAB-node that a BH link could not be recovered from a former RLF.

For instance, the IAB-MT may try to reconnect to its parent IAB-node if it experiences an RLF. In case it fails to reconnect successfully to its parent IAB-node after a certain time period, the IAB-MT may consider that the BH link failure cannot be recovered and a BH link recovery failure has occurred.

In one example, the BH link recovery failure relates to the detection by the DU unit of the IAB-node that a BH link could not be recovered from a former RLF.

For instance, in case of the IAB-DU does not receive any acknowledge following the transmission PDUs for a certain period of time, it may consider that the BH link is in RLF and cannot be recovered.

In one example, the BH link recovery failure relates to the reception by the IAB-node (e.g. the MT unit of the IAB-node) of a Type-4 RLF indication message, as discussed previously at step 703.

In one example, the BH link recovery failure relates to the reception by the IAB-node (e.g. the IAB-DU of the IAB-node) of a flow control feedback message from a child IAB-node (such as child IAB-node 608) indicating congestion affecting transmission of data over a BH link (such as BH link 658 for IAB-node 608).

In one example, the BH link recovery failure relates to the reception by the IAB-node (e.g. the IAB-DU of the IAB-node 605) of a flow control feedback message from a child IAB-node (such as child IAB-node 608) indicating congestion affecting transmission of data over a BH link (such as BH link 658 for IAB-node 608) and the inability for the IAB-DU to apply any corrective action that would alleviate the congestion phenomenon at child IAB-node.

In case a BH link issue related to a BH link recovery failure (i.e. the cause is a long-term type of cause) is detected (yes branch at step 704), the IAB-node 605 determines that the detected link issue provides a long-term link issue (e.g. one of the predetermined link issue criteria representing a cause or source of a long-term link issue is determined to have been met) and triggers a long-term BH link issue at step 707. This includes sending a link failure notification to the donor CU.

In case the BH link issue detected at step 704 is not related to a BH link recovery failure (no branch at step 704), the IAB-node 605 checks, at step 705, if a maximum number of consecutive BH link issues has been reached. In other words, the IAB-node 605 checks whether a number of detected consecutive link issues reaches or exceeds a threshold corresponding to a maximum number of consecutive BH link issues (i.e. whether the cause is a long-term type of cause). The maximum number may be an integer number in the range 3 to 10. In one example, the maximum number may be an integer number in the range 4 to 8. In one example, the maximum number may be 3 or 4.

In case the maximum number of consecutive BH link issues has not been reached or exceeded yet, the IAB-node 605 increments (or decrements) a local BH link issue counter and waits for an update of the recovery status of the ongoing BH link issue at step 706.

In case the maximum number of consecutive BH link issues has been reached (or the threshold has been reached) when the counter is incremented (in the case the counter is decremented, the counter counts down from the maximum number of consecutive BH link issues until it reaches zero), the IAB-node 605 determines that the detected link issue provides a long-term link issue (e.g. one of the predetermined link issue criteria representing a cause or source of a long-term link issue is determined to have been met) and triggers a long-term BH link issue at step 707. This includes sending a link failure notification to the donor CU.

In one example, the local BH link issue counter relates to a single category or nature of BH link issue, as discussed at step 703. For instance, a BH link issue counter is used to keep track of the BH link issues associated with the reception of Type-2 RLF indication message, while another BH link issue counter is used to keep track of the BH link issues associated to the detection of BH Radio Link Failure on an ingress BH link with a parent IAB-node by monitoring the BH link quality. In this example, the category is dependent on not only the type of BH link issue (e.g. RLF type vs congestion type) but also how the link issue is detected. In another example, the category may be dependent on the type of link issue: that is, one local BH link issue counter counts detected RLF link issues and one local BH link issue counter counts detected congestion issues.

In one example, the local BH link issue counter relates to any combination of the several natures or categories of BH link issue, as discussed at step 703.

In one example, the IAB-node 605 uses the maxConsecutiveIssues information, configured by the IAB-donor 601 at step 701, as a threshold to determine if a maximum number of consecutive BH link issues has been reached.

In one example, the IAB-node 605 uses the ConsecutiveIssuesTime Window information, configured by the IAB-donor 601 at step 701, as a sliding time window or link issue recovery time window having a predetermined length to manage the BH link issue counter. In such a case, the BH link issue counter is decremented (or incremented when counting down) each time a past BH link issue has its instant of detection that is no longer inside the sliding time window. The IAB-node 605 checks whether a number of detected consecutive link issues detected during the sliding time window reaches or exceeds a threshold, and when the number of detected link issues reaches or exceeds the threshold, the IAB-node 605 determines that the detected link issue provides a long-term link issue. The threshold corresponds to the maximum number of consecutive BH link issues as discussed above. The length of the sliding time window may range from a few seconds to a few hours. In one example, the length of the sliding time window may range from 2 seconds to 2 hours. In one example, the length of the sliding time window may range from 1 second to 10 hours. Using a sliding time window with a threshold, means that several link issues occurring over a long period of time (e.g. 10 days) is not considered a long-term link issue whereas several link issues occurring over a short period of time (e.g. 1 hour) is considered a long-term link issue.

At step 706, the IAB-node 605 waits for an update of the recovery status of the ongoing BH link issue detected at step 703. In an example, the IAB-node 605 determines whether the detected link issue (detected at step 703) is recovered.

In case the ongoing BH link issue detected at step 703 for a BH link is recovered, the IAB-node 605 detects the BH link is recovered and turns back to operating mode at step 702 and the process starts again with detecting a new link issue at step 703.

In one example, a BH link issue is recovered when the IAB-node 605 (e.g. the IAB-MT of the IAB-node 605) receives an RLF indication message from its parent IAB-node which indicates that a former BH RLF was recovered (Type-3 RLF indication message).

In one example, a BH link issue is recovered when the IAB-node 605 (e.g. the IAB-DU of the IAB-node 605) receives a flow control feedback message form its child IAB-node which indicates that the buffer load at child IAB-node no longer exceeds a certain level.

In one example, a BH link issue is recovered when the IAB-MT of the IAB-node 605 assumes that a BH Radio Link or BH link is no longer broken, in relation with the broken link conditions considered at step 703. For example, by monitoring the BH link quality of the BH link, when the BH link quality reaches or is above a recovery threshold, the IAB-MT can assume the BH link is no longer broken and is recovered. For instance, the IAB-MT may assume that a BH Radio Link is no longer broken in the following if the measured Reference Signal Receive Power (RSRP) reaches or exceeds the predefined threshold or if it succeeded to decode either Physical Downlink Control Channel (PDCCH) or Physical Downlink Shared Channel (PDSCH).

In one example, a BH link issue is recovered when the IAB-DU of the IAB-node 605 assumes that a BH Radio Link is no longer broken, in relation with the broken link conditions considered at step 703. For example, by monitoring the BH link quality of the BH link, when the BH link quality reaches or is above a recovery threshold, the IAB-DU can assume the BH link is no longer broken and is recovered. For instance, IAB-DU may assume that a BH Radio Link or radio link is no longer broken if the Signal-to-interference-plus-noise ratio (SINR) from the child IAB-MT reaches or exceeds a predefined threshold or if the IAB-DU detects an acknowledgement message (e.g. no ACK or NACK) from the child IAB-MT over the Physical Downlink Shared Channel (PDSCH). In one example, a BH link issue is recovered when the IAB-MT or IAB-DU of the IAB-node 605 detects an absence of congestion resulting from a local buffer load that no longer exceeds a certain level.

In case the IAB-node 605 receives, at step 706, a Type-4 RLF indication message, which indicates a BH RLF recovery failure, from its parent IAB-node, the IAB-node 605 determines that the detected link issue provides a long-term link issue (e.g. one of the predetermined link issue criteria representing a cause or source of a long-term link issue is determined to have been met) and triggers a long-term BH link issue at step 707. This includes sending a link failure notification to the donor CU.

In case the IAB-node 605 determines, at step 706, that a BH link issue detected at step 703 was not recovered fast enough (e.g. in response to determining the detected link issue is not recovered within a recovery timeout period), the IAB-node 605 determines that the detected link issue provides a long-term link issue (e.g. one of the predetermined link issue criteria representing a cause or source of a long-term link issue is determined to have been met) and triggers a long-term BH link issue at step 707. This includes sending a link failure notification to the donor CU.

In one example, the IAB-node 605 launches an internal timeout counter at step 703, upon detection of a BH link issue. In case this internal timeout counter reaches a certain recovery timeout value (e.g. which defines a maximum recovery timeout time period between a time of detection of an link issue and a time of recovery from the detected link issue) before the BH link issue is recovered at step 706 (or in the case when the internal timeout counter is decremented with time, the counter counts down from certain recovery timeout value until it reaches zero), as discussed previously, the IAB-node 605 determines that the detected link issue provides a long-term link issue (e.g. one of the predetermined link issue criteria representing a cause or source of a long-term link issue is determined to have been met) and triggers a long-term BH link issue at step 707. In one example, the IAB-node 605 uses the maxRecovery Timeout information, configured by the IAB-donor 701 at step 701, as the recovery timeout value. The recovery timeout time period between a time of detection of a link issue and a time of recovery from the detected link issue may range from a few seconds to a few hours. In one example, the length of the sliding time window may range from 1 second to 1 hour. In one example, the length of the sliding time window may range from 1 second to 30 minutes.

FIG. 8 illustrates an exemplary message flow 800 for reporting long-term link issues for a BH link from an IAB-node 811 which detected the BH link issue, as discussed above with reference to FIGS. 7 and 9, to an IAB-donor CU, according to embodiments and examples of the invention.

In one example, upon detection of a long-term link issue, such as a long-term BH RLF issue, an IAB-node 811, such as IAB-node 605 of FIG. 6, may notify IAB-donor CU 810, such as the CU of IAB-donor 601 of FIG. 6, of such detection by sending a link failure notification using BH LINK FAILURE INFORMATION message 802.

In one example, IAB-donor CU 810, such as IAB-donor 601, may send a request to an IAB-node 811, such as IAB-node 605, requesting the IAB-node 811 provides some link information, for example, information on potential long-term link issues, such as long-term BH RLF issues, the IAB-node 811 may have detected, by sending a BH LINK FAILURE POLLING message 801. In response to this message 801, IAB-node 811 notifies IAB-donor 810 of the BH link issues it detected by sending a link failure notification using BH LINK FAILURE INFORMATION message 802.

In one example, message 802 embeds the BHLinkIssueInfo Information Element (IE), which comprises, for a given BH link issue detected according to the method described above with respect to FIG. 7 or 9, all or part of the following information:
A BH Link information, which identifies the BH link for which the link issue was detected. This BH Link information may include all or part of the following information: 1) the BAP address of the IAB-nodes at both ends of the BH Link, 2) a Cell ID information, identifies the cell the BH Link belongs to, 3) one or more RLC channel IDs, which identify the one or more RLC Channels impacted by the detected issue, 4) one or more BAP routing IDs, which identify the BAP Routing information (i.e. BAP address and Path ID) associated to the BH link in failure impacted by the detected issue.
A Long Term BH Link Issue Indication information, which indicates that a long-term failure or link issue has occurred on the BH link identified by the aforementioned BH Link information.
A Long Term BH Link Issue Cause information, which indicates the cause for the long-term link issue. This information may indicate a BH link recovery failure, BH link slow recovery or successive (or repeating or recurring) BH link issues, as discussed above with reference to FIGS. 7 and/or 9.
A Long Term BH Link Issue Typeof Cause information, which indicates the type of the cause for the long-term link issue, such as, a long-term cause or a short-term cause) as discussed above with reference to FIGS. 7 and/or 9.
An RLF Indication information, which indicates that the long-term failure or link issue results from a BH Radio Link Failure (RLF), as discussed above with reference to FIGS. 7 and/or 9.
A Congestion Indication information, which indicates that the long-term failure or link issue results from a congestion phenomenon, as discussed above with reference to FIGS. 7 and/or 9.
A Link Quality Information, which indicates the quality of the BH link impacted by the BH link issue (e.g. SINR, congestion level . . . ).
An Ageing information, which provides some timing information related to the instant of detection of the BH link issue.

In one embodiment of the invention, message 801 is the UEInformationRequest message defined in 3GPP TS 38.331, while message 802 is the UEInformationResponse message defined in 3GPP TS 38.331.

In one embodiment of the invention, message 802 is the MCGFailureInformation message defined in 3GPP TS 38.331.

In one embodiment of the invention, message 802 is the SCGFailureInformation message defined in 3GPP TS 38.331.

In one embodiment of the invention, message 802 is the FailureInformation message defined in 3GPP TS 38.331.

In one embodiment of the invention, message 802 is the MeasurementReport message defined in 3GPP TS 38.331.

In one embodiment of the invention, message 802 is the GNB-DU STATUS INDICATION message defined in 3GPP TS 38.473.

In one embodiment of the invention, message 802 is the ASSISTANCE INFORMATION DATA frame defined in 3GPP TS 38.425 that specifies the NR user plane protocol. The ASSISTANCE INFORMATION DATA frame is conveyed by GTP-U protocol means, more specifically, by means of the “NR RAN Container” GTP-U extension header as defined in TS 29.281.

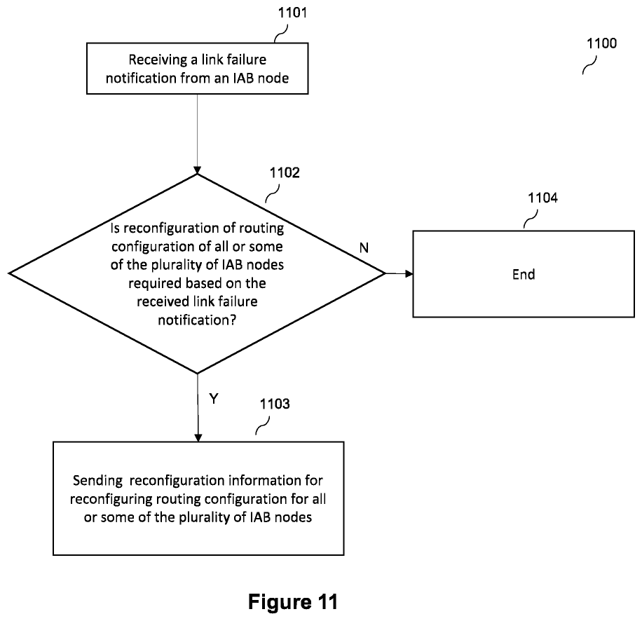

FIG. 11 shows steps of a method 1100 performed at donor CU (also referred to as IAB-donor CU) in accordance with an embodiment of the present invention. The donor CU is part of an IAB donor (such as IAB donor 601 in FIG. 6) of an IAB network comprising a plurality of IAB nodes. The donor CU may be IAB-donor CU 810 shown in FIG. 8. The donor CU may be implemented in a communication device 1000 as shown in FIG. 10 below with the method as described with reference to FIG. 11 being performed by the central processing unit 1011.

Briefly, at step 1101, the donor CU receives, from an IAB node (such as IAB node 605 of FIG. 6 or IAB node 811 of FIG. 8), a link failure notification. The link failure notification includes link issue information relating to a detected link issue (e.g. long-term link issue) for transmission of data over a backhaul link of the IAB network and link information identifying the backhaul link. The link issue information includes information identifying the detected link issue and information associated with a cause of the detected link issue. Details of the link failure notification (e.g. the messages that may be used to send the notification and the contents of the notification) are as discussed above with reference to FIGS. 7 to 9.

The donor CU determines at step 1102 whether reconfiguration of routing configuration of all or some of the plurality of IAB nodes in the IAB network is required based on the received link failure notification. In response to determining reconfiguration is required (Yes branch at step 1102), the donor CU sends reconfiguration information for reconfiguring routing configuration for all or some of the plurality of IAB nodes (e.g. by sending configuration information to update the Backhaul Routing Configuration table described above with reference to FIG. 5a and/or configuration information to update some or all of the tables described with reference to FIGS. 5b to 5d).

FIG. 10 shows a schematic representation of an example communication device or station, in accordance with one or more embodiments and examples of the present disclosure.

The communication device 1000 may preferably be a device such as a micro-computer, a workstation or a light portable device. The communication device 1000 comprises a communication bus 1013 to which there are preferably connected:
a central processing unit 1011, such as a microprocessor, denoted CPU;
memory for storing data and computer programs containing instructions for the operation of the communication device 1000. The computer programs may contain a number of different program elements or sub-routines containing instructions for a variety of operations and for implementing the invention. For example, the program elements may include an element to implement a BAP entity which as discussed above is for routing of data packets between different the MT and DU of an IAB node and between different network nodes in the IAB network; and
at least one communication interface 1002 connected to the radio communication network 100 over which digital data packets or frames or control frames are transmitted, for example a wireless communication network according to the release 16 for 5G NR. The frames are written from a FIFO sending memory in RAM 1012 to the network interface for transmission or are read from the network interface for reception and writing into a FIFO receiving memory in RAM 1012 under the control of a software application running in the CPU 1011.

Each of a donor CU, an IAB network node and a donor DU may comprise such a communication device 1000.

The central processing unit 1011 may be a single processor or may comprise two or more processors carrying out the processing required for the operation of the communication device 1000. The number of processors and the allocation of processing functions to the central processing unit 1011 is a matter of design choice for a skilled person.

The memory may include:
a read only memory 1007, denoted ROM, for storing computer programs for implementing the invention;
a random-access memory 1012, denoted RAM, for storing the executable code of methods according to one or more embodiments of the invention as well as the registers adapted to record variables and parameters necessary for implementing methods according to one or more embodiments of the invention.

Optionally, the communication device 1000 may also include the following components:
a data storage means 1004 such as a hard disk, for storing computer programs for implementing methods according to one or more embodiments of the invention;
a disk drive 1005 for a disk 1006, the disk drive being adapted to read data from the disk 1006 or to write data onto said disk;
a screen 1009 for displaying decoded data and/or serving as a graphical interface with the user, by means of a keyboard 1010 or any other pointing means.

Preferably the communication bus provides communication and interoperability between the various elements included in the communication device 1000 or connected to it. The representation of the bus is not limiting and in particular, the central processing unit is operable to communicate instructions to any element of the communication device 1000 directly or by means of another element of the communication device 1000.

The disk 1006 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 1007, on the hard disk 1004 or on a removable digital medium such as for example a disk 1006 as described previously. According to an optional variant, the executable code of the programs can be received by means of the communication network 1003, via the interface 1002, in order to be stored in one of the storage means of the communication device 1000, such as the hard disk 1004, before being executed.

The central processing unit 1011 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 1004 or in the read only memory 1007, are transferred into the random-access memory 1012, which then contains the executable code of the program or programs, as well as registers for storing the variables and parameters necessary for implementing the invention.

In an embodiment, the apparatus is a programmable apparatus which uses software to implement the invention. However, alternatively, the present invention may be implemented in hardware (for example, in the form of an Application Specific Integrated Circuit or ASIC).

Local rerouting may be beneficial for the mitigation of congestion and for load balancing. Moreover, local rerouting may be triggered by Type-2 RLF indication or by indication of hop-by-hop flow control.

In this respect, one may observe that local re-routing may allow mitigating short-term (transient) BH link issue (RLF/BH link quality/congestion) phenomena.

However, this local rerouting may increase the risk of congestion at another IAB-node (i.e. moving the issue from one place to another). Therefore, local rerouting may be performed for a limited period of time. Thus, even if local re-routing, by allowing fast link adaptation, provides an efficient means to mitigate the impact of local BH Link issue, it may not be suited for long-term BH link issue

In this respect, one may observe that Long-term BH Link issue may require the IAB-Donor to reconfigure the routing configuration of all or part of the IAB-nodes.

Even if short-term issue may be addressed through local re-routing, a long-term RLF/congestion may require a new routing configuration of IAB-nodes in order to adapt to the new situation. However, the IAB-Donor does not have any knowledge on local BH link issues, both short-term and long-term (as of Rel. 16).

In this respect, one may observe that 3GPP Rel. 16 provides few services to inform the IAB-Donor of a BH Link issue, especially there is no means for signalling long-term/short-term BH link issues.

To solve the above issues, it is proposed to differentiate the short-term BH link issues that could be handled at IAB-node level, by apply local rerouting for instance, from the long-term BH link issues that would require some reconfiguration of all or part of the topology at IAB-donor level.

The BH link issue may result from a Radio Link Failure or some congestion at an IAB-node, which may impact one or more BH links. Several causes may trigger a “long-term BH link issue, such as an RLF recovery failure or a sequence of RLF detection/RLF recovery or a sequence of congestion detection/congestion recovery.

An IAB-MT, resp. IAB-DU, may detect such BH link issue at its own level, or by receiving feedback messages, such as an RLF indication message (Type1, 2 or 4) or a flow control feedback message.

Upon detection of a long-term BH link issue, the IAB-node may therefore notify the IAB-donor of such an issue.

In order to allow the IAB-donor to apply efficient reconfiguration to solve, or at least mitigate, this issue, an IAB-node may provide the IAB-donor with some information on the one or more BH links experiencing a BH link issue, e.g. BAP address, RLC Channel ID or BAP routing ID as well as information on the cause of the long-term BH link issue, e.g. recovery failure, BH link issue repetition. The IAB-node may also inform the IAB-donor on whether the BH link issue results from an RLF or congestion phenomenon.

As such long-term BH link issue may be detected at either the MT unit or the DU unit of an IAB node, one may consider both RRC and F1-AP protocols for the IAB-node to notify the IAB-donor of the detection of long-term BH link issue.

In relation with the above observations, it is therefore proposed that an IAB-node may notify the IAB-donor of the detection of long-term BH link issue, i.e. a BH link issue which requires some reconfiguration at IAB-donor level.

It is also proposed that an IAB-node may indicate to the IAB-donor the cause of a long-term BH link issue, e.g. recovery failure, BH link issue repetition.

It is also proposed that an IAB-node may indicate to the IAB-donor whether the BH link issue results from RLF or congestion.

It is also proposed that an IAB-node may notify the IAB-donor of a BH link issue using either RRC or F1-AP messages.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

Reference numerals appearing in the claims are by way of illustration only and shall have no limiting effect on the scope of the claims.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1. A method at an Integrated Access and Backhaul, IAB, node of an IAB network, the IAB network including a donor Central Unit, CU, the method comprising:
in response to detecting a link issue, the detected link issue being congestion affecting transmission of data over a backhaul link, sending a link failure notification to the donor CU, wherein the link failure notification includes link identification information identifying the backhaul link and link issue information relating to the detected link issue, wherein the link issue information includes information indicating the detected link issue is congestion.

2. The method of claim 1, wherein the link issue information includes information indicating the cause of the detected link issue or information indicating a type of the cause of the detected link issue.

3. The method of claim 2, wherein the type of the cause of the detected link issue is one of a long-term cause or a short-term cause.

4-13. (canceled)

14. The method of claim 1, wherein the link issue information relating to the detected link issue further includes at least one of:
information indicating a nature of the detected link issue;
information identifying a type of the detected link issue;
information indicating the link quality of the backhaul link;
link issue time information indicating a time between detecting the link issue and sending the link failure notification.

15. The method of claim 1, wherein the link information identifying the backhaul link includes at least one of:
unique addresses of IAB nodes at both ends of the backhaul link;
a BAP address of a IAB node of the backhaul link;
cell identifier identifying a cell associated with the backhaul link;
RLC channel identifier identifying the RLC channel associated with the link issue of the backhaul link;
BAP routing identifier.

16. The method of claim 1, further comprising receiving a request from the donor CU for link information, wherein sending comprises sending the link failure notification in response to the received request.

17. The method of claim 1, further comprising detecting a link issue for transmission of data over the backhaul link, wherein detecting a link issue comprises at least one of:
monitoring a load of a buffer of the IAB node, the buffer being associated with the backhaul link, and when the load exceeds a congestion threshold, detecting congestion at the buffer, wherein the detected link issue is congestion for transmitting data over the backhaul link;
receiving a flow control feedback message associated with the backhaul link and determining from the flow control feedback message congestion over the backhaul link, wherein the detected link issue is congestion for transmitting data over the backhaul link.

18-20. (canceled)

21. The method of claim 1, wherein the IAB node comprises a Distributed Unit, DU, and wherein sending a link failure notification to the donor CU are performed by the DU of the IAB node.

22. The method of claim 21, wherein sending comprises sending, by the DU of the IAB node, the link failure notification in a F1 Application Protocol, F1-AP, layer message.

23. (canceled)

24. A method at a donor Central Unit, CU, of an Integrated Access and Backhaul, IAB, network, the IAB network including a plurality of IAB nodes, the method comprising:
receiving, from an IAB node, a link failure notification, wherein the link failure notification includes link issue information relating to a detected link issue for transmission of data over a backhaul link of the IAB network and link information identifying the backhaul link, wherein the link issue information includes information indicating the detected link issue is congestion;
determining whether reconfiguration of routing configuration of all or some of the plurality of IAB nodes is required based on the received link failure notification; and
in response to determining reconfiguration is required, sending reconfiguration information for reconfiguring routing configuration for all or some of the plurality of IAB nodes.

25. The method of claim 24, wherein the link issue information includes information indicating the cause of the detected link issue or information indicating a type of the cause of the detected link issue.

26. The method of claim 25, wherein the type of the cause of the detected link issue is one of a long-term cause or a short-term cause.

27-29. (canceled)

30. The method of claim 24, wherein the link issue information further includes at least one of:
information indicating a nature of the detected link issue;
information identifying a type of the detected link issue;
information indicating the link quality of the backhaul link;
link issue time information indicating a time between detecting the link issue and sending the link failure notification.

31. The method of claim 24, wherein the link information identifying the backhaul link includes at least one of:
unique addresses of IAB nodes at both ends of the backhaul link;
a BAP address of an IAB node of the backhaul link;
cell identifier identifying a cell associated with the backhaul link;
RLC channel identifier identifying the RLC channel associated with the link issue of the backhaul link;
BAP routing identifier.

32. The method of claim 24, wherein receiving a link failure notification, comprises: receiving, from a Distributed Unit, DU, of the IAB node, the link failure notification in a F1 Application Protocol, F1-AP, layer message.

33. The method of claim 24, further comprising:
sending, to the plurality of IAB nodes, backhaul link failure configuration information including:
information indicating a maximum number of detected consecutive link issues for data transmission over the backhaul link;
recovery timeout information indicating a maximum time period between a time of detection of a link issue and a time of recovery from the detected link issue;
a link issue recovery time window having a predetermined length, during which a maximum number of consecutive link issues may be detected.

34. An apparatus for an Integrated access and backhaul, IAB, node for an IAB network, the apparatus comprising:
one or more processors configured to:
in response to detecting a link issue, the detected link issue being congestion affecting transmission of data over a backhaul link, send a link failure notification to a donor Central Unit, CU, of the IAB network, wherein the link failure notification includes link identification information identifying the backhaul link and link issue information relating to the detected link issue, wherein the link issue information includes information indicating the detected link issue is congestion.

35. An apparatus for a donor Central Unit, CU, for an integrated access and backhaul, IAB, network comprising a plurality of IAB nodes, the apparatus comprising:
one or more processors configured to:
receive, from an IAB node, a link failure notification, wherein the link failure notification includes link issue information relating to a detected link issue for transmission of data over a backhaul link of the IAB network and link information identifying the backhaul link, wherein the link issue information includes information indicating the detected link issue is congestion;
determine whether reconfiguration of routing configuration of all or some of the plurality of IAB nodes is required based on the received link failure notification; and
in response to determining reconfiguration is required, send reconfiguration information for reconfiguring routing configuration for all or some of the plurality of IAB nodes.

36. A non-transitory computer-readable storage medium carrying a computer program comprising instructions which, when the program is executed by one or more processors of an Integrated access and backhaul, IAB, node for an IAB network, cause the one or more processors to:
in response to detecting a link issue, the detected link issue being congestion affecting transmission of data over a backhaul link, send a link failure notification to a donor Central Unit, CU, of the IAB network, wherein the link failure notification includes link identification information identifying the backhaul link and link issue information relating to the detected link issue, wherein the link issue information includes information indicating the detected link issue is congestion.

37. A non-transitory computer-readable storage medium carrying a computer program comprising instructions which, when the program is executed by one or more processors of a donor Central Unit, CU, for an integrated access and backhaul, IAB, network, cause the one or more processors to:
receive, from an IAB node, a link failure notification, wherein the link failure notification includes link issue information relating to a detected link issue for transmission of data over a backhaul link of the IAB network and link information identifying the backhaul link, wherein the link issue information includes information indicating the detected link issue is congestion;
determine whether reconfiguration of routing configuration of all or some of a plurality of IAB nodes of the IAB network is required based on the received link failure notification; and
in response to determining reconfiguration is required, send reconfiguration information for reconfiguring routing configuration for all or some of the plurality of IAB nodes.

38. The method of claim 1, wherein the link information identifying the backhaul link is a BAP address of an IAB node of the backhaul link.

39. The method of claim 24, wherein the link information identifying the backhaul link is a BAP address of an IAB node of the backhaul link.

40. The apparatus of claim 34, wherein the link issue information includes information indicating the cause of the detected link issue or information indicating a type of the cause of the detected link issue.

41. The apparatus of claim 34, wherein the link issue information relating to the detected link issue further includes at least one of:
information indicating a nature of the detected link issue;
information identifying a type of the detected link issue;
information indicating the link quality of the backhaul link;
link issue time information indicating a time between detecting the link issue and sending the link failure notification.

42. The apparatus of claim 34, wherein the link information identifying the backhaul link includes at least one of:
unique addresses of IAB nodes at both ends of the backhaul link;
a BAP address of a IAB node of the backhaul link;
cell identifier identifying a cell associated with the backhaul link;
RLC channel identifier identifying the RLC channel associated with the link issue of the backhaul link;
BAP routing identifier.

43. The apparatus of claim 34, wherein the link information identifying the backhaul link is a BAP address of an IAB node of the backhaul link.

44. The apparatus of claim 34, the one or more processors are further configured to receive a request from the donor CU for link information, wherein the one or more processors are configured to send the link failure notification by sending the link failure notification in response to the received request.

45. The apparatus of claim 34, the one or more processors are further configured to detect a link issue for transmission of data over the backhaul link, wherein the one or more processors are configured to detect a link issue by at least one of:
monitoring a load of a buffer of the IAB node, the buffer being associated with the backhaul link, and when the load exceeds a congestion threshold, detecting congestion at the buffer, wherein the detected link issue is congestion for transmitting data over the backhaul link;
receiving a flow control feedback message associated with the backhaul link and determining from the flow control feedback message congestion over the backhaul link, wherein the detected link issue is congestion for transmitting data over the backhaul link.

46. The apparatus of claim 34, wherein the IAB node comprises a Distributed Unit, DU, and wherein the one or more processors are configured to send a link failure notification to the donor CU by the DU of the IAB node.

47. The apparatus of claim 46, wherein the one or more processors are configured to send, by the DU of the IAB node, the link failure notification in a F1 Application Protocol, F1-AP, layer message.

48. The apparatus of claim 35, wherein the link issue information includes information indicating the cause of the detected link issue or information indicating a type of the cause of the detected link issue.

49. The apparatus of claim 35, wherein the link issue information further includes at least one of:
information indicating a nature of the detected link issue;
information identifying a type of the detected link issue;
information indicating the link quality of the backhaul link;
link issue time information indicating a time between detecting the link issue and sending the link failure notification.

50. The apparatus of claim 35, wherein the link information identifying the backhaul link includes at least one of:
unique addresses of IAB nodes at both ends of the backhaul link;
a BAP address of an IAB node of the backhaul link;
cell identifier identifying a cell associated with the backhaul link;
RLC channel identifier identifying the RLC channel associated with the link issue of the backhaul link;
BAP routing identifier.

51. The apparatus of claim 35, wherein the link information identifying the backhaul link is a BAP address of an IAB node of the backhaul link.

52. The apparatus of claim 35, wherein the one or more processors are configured to receive a link failure notification from a Distributed Unit, DU, of the IAB node, in a F1 Application Protocol, F1-AP, layer message.

53. The apparatus of claim 35, wherein the one or more processors are further configured to:
send, to the plurality of IAB nodes, backhaul link failure configuration information including:
information indicating a maximum number of detected consecutive link issues for data transmission over the backhaul link;
recovery timeout information indicating a maximum time period between a time of detection of a link issue and a time of recovery from the detected link issue;
a link issue recovery time window having a predetermined length, during which a maximum number of consecutive link issues may be detected.
